(19) United States
(12) Patent Application Publication
(10) Pub. No.: US 2024/0216907 A1
(43) Pub. Date: Jul. 4, 2024

(54) EXTRACTION OF LIQUID FROM PIERCEABLE LIQUID STORAGE CONTAINER

(71) Applicant: OSLER DIAGNOSTICS LIMITED, Oxford (GB)

(72) Inventors: Barry LILLIS; Jasper MALINSON; Jimishkumar PATEL; Myles WHITING; Mark HYLAND; Nuno REIS; Amanda PUNIM; Dylann CERIANI

(21) Appl. No.: 18/293,283

(22) PCT Filed: Jul. 29, 2022
(86) PCT No.: PCT/EP2022/071433

§ 371 Date: Jan. 29, 2024

Related U.S. Application Data
(60) Provisional application No. 63/227,146, filed on Jul. 29, 2021.

(51) Int. Cl. B01L 3/00

(52) U.S. Cl. CPC B01L 3/502; B01L 2200/026; B01L 2200/0684; B01L 2200/0689; B01L 2300/0672; B01L 2300/0681; B01L 2400/0478

(57) ABSTRACT

Embodiments described herein relate to a liquid extraction device for extracting liquid from a pierceable liquid storage container, the liquid extraction device comprising: a liquid storage container interface configured to provide a fluidic connection to a volume of liquid within the liquid storage container, the liquid storage container interface comprising a liquid extraction outlet configured to allow liquid to be extracted from the liquid storage container; and a liquid extraction mechanism actuatable from a first configuration to a second configuration; wherein the liquid extraction mechanism is configured to provide a pressure difference between a volume of gas in the liquid storage container and the liquid extraction outlet, when the liquid extraction mechanism is actuated from the first configuration to the second configuration.

### FIELD

The present disclosure relates to devices and methods for extracting liquid from a pierceable liquid storage container, such as a blood collection tube.

### BACKGROUND

Point-of-care diagnostic devices are typically used for carrying out diagnostic tests, such as immunoassays, on a biological sample (such as whole blood, blood serum or blood plasma). In order to carry out such diagnostic tests, the biological sample needs to be transferred to the diagnostic device. The diagnostic device is subsequently inserted into an analyser device (or instrument), which controls the movement of fluids (e.g. biological samples, reagents, buffer solutions, etc.) within the diagnostic device and conducts measurements of biomarkers, in order to conduct the diagnostic test.

Biological samples such as whole blood or blood plasma are typically collected from a subject using a pierceable liquid storage container such as a blood collection tube, also commonly referred to as a venous blood tube or as a Vacutainer (RTM). Existing systems for extracting liquid samples from blood collection tubes involve coupling the blood collection tube to the diagnostic device, and subsequently inserting the diagnostic device and coupled blood collection tube into the analyser device. Diagnostic tests can take several minutes to perform, meaning that any remaining quantity of biological sample within the blood collection tube cannot be used until the diagnostic device has been removed from the analyser device, following completion of the diagnostic test. Accordingly, a drawback of such existing systems is that a biological sample within a blood collection tube cannot be utilised until a particular diagnostic test has been completed. A further drawback of existing systems is that the blood collection tube may include solutions (e.g. control or calibration solutions) that may degrade if not kept under certain conditions (e.g. specific storage temperatures such as 2-8° C.).

Other existing systems require a blood collection tube to be de-capped prior to transfer of the biological sample. For example, the biological sample may be manually transferred from a de-capped blood collection tube to the diagnostic device by the user (e.g. using a pipette). In alternative examples, an adapter device may be fitted to the blood collection tube after de-capping the tube, where the adapter device is subsequently attached to a diagnostic device in order to transfer the biological sample to the diagnostic device. Accordingly, a drawback of such existing systems is that a user of the diagnostic device is required to carry out additional manual operations in order to effect transfer of the biological sample from the blood collection tube to the diagnostic device.

Accordingly, there exists a need for devices for extracting liquid from a liquid storage container (e.g. a blood collection tube) that allow any remaining sample within the liquid storage container to be utilised while a particular diagnostic test is being carried out, that minimise the handling time of liquid storage containers, and that are easy to use.

### SUMMARY

This summary introduces concepts that are described in more detail in the detailed description. It should not be used to identify essential features of the claimed subject matter, nor to limit the scope of the claimed subject matter.

According to one aspect of the present disclosure, there is provided a liquid extraction device for extracting liquid from a pierceable liquid storage container, the liquid extraction device comprising: a liquid storage container interface configured to provide a fluidic connection to a volume of liquid within the liquid storage container, the liquid storage container interface comprising a liquid extraction outlet configured to allow liquid to be extracted from the liquid storage container; and a liquid extraction mechanism actuatable from a first configuration to a second configuration; wherein the liquid extraction mechanism is configured to provide a pressure difference between a volume of gas in the liquid storage container and the liquid extraction outlet, when the liquid extraction mechanism is actuated from the first configuration to the second configuration.

The liquid extraction device allows a user to extract liquid from a liquid storage container (such as a blood collection tube) by actuation of the liquid extraction mechanism. Given that the liquid storage container interface is configured to provide a fluidic connection to the volume of liquid within the liquid storage container, the user is not required to de-cap a blood collection tube or to fit any form of adapter device to the blood collection tube. Accordingly, the liquid extraction device provides improved ease of extracting liquid from a liquid storage container over existing systems.

The liquid extraction device may be suitable for extracting liquid from a blood collection tube, and may comprise a blood collection tube interface configured to provide a fluidic connection to a volume of liquid within the blood collection tube.

The liquid storage container interface may be configured to permit removal of the liquid storage container from the liquid storage container interface after extraction of liquid from the liquid storage container. Accordingly, once a desired quantity of liquid has been extracted from the liquid storage container, the liquid storage container can be re-utilised while a particular diagnostic test is being carried out on the extracted liquid.

The liquid storage container interface may comprise at least one piercing element (e.g. a needle) configured to provide the fluidic connection to the volume of liquid within the liquid storage container. The piercing element may also be configured to provide the attachment between the liquid extraction device and the liquid storage container. The piercing element may be configured to pierce the liquid storage container to provide the fluidic connection to the volume of liquid. For example, the piercing element may be configured to pierce a septum of the liquid storage container, such as a septum of a blood collection tube.

The liquid extraction mechanism may comprise a piston moveable within a receptacle, wherein the piston is actuatable from the first configuration to the second configuration. The receptacle may be configured to receive a portion of the liquid storage container, such as an end portion of a blood collection tube, wherein the end portion of the blood collection tube comprises a pierceable septum. The receptacle may comprise an outlet via which liquid extracted from the liquid storage container may be removed. The outlet may be provided in an end wall of the receptacle. Alternatively, the outlet may be provided in a side wall of the receptacle. The liquid extraction device may further comprise a connector in fluidic communication with the outlet, wherein the connector is configured to provide a fluidic connection to a liquid handling device such as a microfluidic cartridge.

The receptacle may comprise a dividing wall defining an internal chamber within the receptacle. The liquid extraction outlet may be in fluidic communication with the chamber within the receptacle. The outlet from the liquid extraction device may be provided in a wall of the chamber within the receptacle. The dividing wall may comprise an aperture comprising a pierceable seal, wherein the liquid storage container interface is further configured to pierce the pierceable seal when the piston is in the second configuration, to generate the pressure difference between the volume of gas and the liquid extraction outlet.

The liquid storage container interface may be attached to the piston. Accordingly, the liquid storage container interface may be actuated together with the piston as the piston is actuated from the first configuration to the second configuration.

The liquid extraction outlet may be in fluidic communication with a chamber defined by the piston and the receptacle, wherein the chamber is in fluidic communication with the liquid extraction outlet. The chamber may be configured to store a quantity of liquid extracted from the liquid storage container.

The piston may be configured to increase the pressure of air within the chamber when the piston is actuated from the first configuration to the second configuration. To increase the pressure of air within the chamber, the piston may be configured to reduce the volume of the chamber when the piston is actuated from the first configuration to the second configuration.

The liquid extraction device may further comprise a sealing element configured to provide a seal between the piston and the receptacle when the piston is in the first configuration. The sealing element may seal the piston during actuation of the piston from the first configuration to the second configuration.

The liquid extraction mechanism may be configured to provide the pressure difference between the volume of gas in the blood collection tube and the liquid extraction outlet once the liquid extraction mechanism is in the second configuration.

The liquid extraction device may further comprise a seal compromising element configured to compromise the sealing element once the piston is in the second configuration. Compromising the sealing element may cause the release of air from the chamber, thereby generating a pressure difference between the liquid extraction outlet in fluidic communication with the chamber, and the volume of gas within the liquid storage container.

The seal compromising element may comprise an aperture configured to compromise the sealing element when the piston is in the second configuration, such that air within the chamber is released via the aperture.

The liquid extraction device may further comprise an air filter configured to control the flow of air released via the aperture. By controlling the flow of air released via the aperture, the rate of change of pressure within the chamber (i.e. at the liquid extraction outlet) is slowed down. This, in turn, slows the rate of extraction of liquid from the liquid storage container. In an example where the liquid storage container is a blood collection tube storing a volume of blood, slowing down the rate of extraction of blood from the blood collection tube reduces the tendency for haemolysis to occur as blood is extracted.

The seal compromising element may be a first seal compromising element, and the liquid extraction device may further comprise a second seal compromising element configured to compromise the sealing element when the piston is actuated to a position in between the first configuration and the second configuration. By including multiple sealing elements, the liquid can be extracted from the liquid storage container in stages, which reduces the pressure difference that is generated between the liquid extraction outlet and the volume of gas within the liquid storage container. In an example where the liquid storage container is a blood collection tube storing a volume of blood, reducing the pressure difference leads to a reduction in the tendency for haemolysis to occur during extraction of blood.

The liquid extraction mechanism may be configured to provide the pressure difference between the volume of gas in the blood collection tube and the liquid extraction outlet during actuation of the liquid extraction mechanism from the first configuration to the second configuration. Providing the pressure difference during actuation of the liquid extraction mechanism allows liquid to be extracted from the liquid storage container as the liquid extraction mechanism is actuated. This means that liquid can be extracted from the liquid storage container using a lower pressure difference than in implementations in which a step change in pressure difference is provided. In an example where the liquid storage container is a blood collection tube storing a volume of blood, reducing the pressure difference leads to a reduction in the tendency for haemolysis to occur during extraction of blood.

The piston may be configured to reduce the pressure within the chamber below the pressure of the volume of gas within the liquid storage container, when the piston is actuated from the first configuration to the second configuration.

The liquid storage container interface may comprise at least two needles; wherein a first one of the at least two needles is configured to provide the fluidic connection to the volume of liquid within the liquid storage container, wherein the first one of the at least two needles is in fluidic communication with the liquid extraction outlet; wherein a second one of the at least two needles is configured to provide a fluidic connection to the liquid storage container; and wherein the liquid extraction mechanism is configured to supply air through the second one of the at least two needles. As with the above examples, this allows liquid to be extracted during actuation of the liquid extraction mechanism which, in the example of blood extraction, reduces the tendency for haemolysis to occur.

The liquid extraction device may further comprise a resiliently deformable element configured to bias the piston away from the first configuration towards the second configuration. The resiliently deformable element allows for a controlled change in pressure, because the rate of change of pressure is defined by the resiliently deformable element, and not by application of a force by the user. Again, this may reduce the tendency for haemolysis to occur in examples where blood is extracted from a blood collection tube.

The liquid extraction device may further comprise at least one clip configured to hold the piston in the first configuration, in which the resiliently deformable element is in a deformed state. The at least one clip allows the liquid extraction mechanism to be actuated by the action of the resiliently deformable element, once the piston has been unclipped. Specifically, the at least one clip avoids the need for the user to apply a downward force to deform the resiliently deformable element. This minimises the user action required in order to actuate the liquid extraction mechanism, improving the ease of use of the device.

The liquid extraction device may further comprise a porous medium (e.g. a plasma separation membrane) in fluidic communication with the liquid extraction outlet. Implementing a porous medium allows additional functionality to be provided by the liquid extraction device. As one example, implementing a plasma separation membrane allows blood plasma to be transferred to a liquid handling device so that a diagnostic test can be carried out on the blood plasma, thereby avoiding the need for the liquid handling device to include a separate plasma separation membrane.

The liquid extraction mechanism may be external to the receptacle. The liquid extraction mechanism may comprise a plunger moveable within a housing, and an air transfer conduit in fluidic communication with the housing and the receptacle, wherein actuation of the plunger causes air to be transferred from the housing to the receptacle (specifically, to the liquid storage container via the liquid extraction outlet). The liquid extraction mechanism may alternatively comprise a suction tab within a housing, wherein the suction tab is configured to transfer air from an internal chamber within the receptacle to the housing, to provide a pressure difference between the volume of gas within the liquid storage container, and the internal chamber.

According to another aspect of the present disclosure, there is provided a liquid extraction device for extracting liquid from a pierceable liquid storage container, the liquid extraction device comprising: a chamber comprising an outlet configured to vent the chamber; a first liquid storage container interface configured to provide a fluidic connection to a volume of liquid within the liquid storage container, the first liquid storage container interface comprising a liquid extraction outlet in fluidic communication with the chamber; and a second liquid storage container interface configured to provide a fluidic connection to a volume of gas within the liquid storage container, wherein the second liquid storage container interface is configured to vent the volume of gas.

The liquid extraction device according to this aspect allows liquid to be extracted from a liquid storage container using a device that includes no moving parts. Accordingly, the device has a simple construction and may be easier to manufacture.

The liquid extraction device may comprise a receptacle housing the first and second liquid storage container interfaces. The receptacle may be configured to receive a portion of the liquid storage container, such as an end portion of a blood collection tube, wherein the end portion of the blood collection tube comprises a pierceable septum. The chamber may be provided within the receptacle. An end portion of the first and second liquid storage container interfaces may protrude into the chamber. The second liquid storage container interface may provide a fluidic connection between the volume of gas and the chamber, such that the second liquid storage container interface may vent the volume of gas to the chamber. Each liquid storage container interface may comprise a needle configured to pierce the liquid storage container (e.g. to pierce a septum of a blood collection tube).

According to a further aspect of the present disclosure, there is provided a liquid handling apparatus comprising: a liquid handling device comprising one or more conduits; and a liquid extraction device according to any of the above aspects; wherein the liquid extraction device is in fluidic communication with at least one of the one or more conduits.

The liquid handling device may be suitable for use in carrying out a diagnostic test. The liquid extraction device may be integrated within the liquid handling device. Alternatively, the liquid extraction device may be attachable to the liquid handling device. For example, the liquid extraction device may be removably attachable to the liquid handling device.

### BRIEF DESCRIPTION OF FIGURES

Specific embodiments are described below by way of example only and with reference to the accompanying drawings, in which:

FIG. 1 is a schematic diagram of a first liquid extraction device in fluidic communication with a cartridge.

FIG. 2A is a schematic diagram of an attachment between the first liquid extraction device and a cartridge.

FIG. 2B is a schematic diagram of an attachment between a second liquid extraction device and a cartridge.

FIGS. 3A to 3D show the second liquid extraction device being used to extract liquid from a blood collection tube, at various stages of the liquid extraction procedure.

FIGS. 4A to 4D show the first liquid extraction device being used to extract liquid from a blood collection tube, at various stages of the liquid extraction procedure.

FIGS. 5A to 5D show a third liquid extraction device being used to extract liquid from a blood collection tube, at various stages of the liquid extraction procedure.

FIGS. 6A to 6D show a fourth liquid extraction device being used to extract liquid from a blood collection tube, at various stages of the liquid extraction procedure.

FIGS. 7A to 7D show a fifth liquid extraction device being used to extract liquid from a blood collection tube, at various stages of the liquid extraction procedure.

FIGS. 8A to 8D show a sixth liquid extraction device being used to extract liquid from a blood collection tube, at various stages of the liquid extraction procedure.

FIGS. 9A to 9D show a seventh liquid extraction device being used to extract liquid from a blood collection tube, at various stages of the liquid extraction procedure.

FIGS. 10A to 10D show an eighth liquid extraction device being used to extract liquid from a blood collection tube, at various stages of the liquid extraction procedure.

FIGS. 11A to 11D show a ninth liquid extraction device being used to extract liquid from a blood collection tube, at various stages of the liquid extraction procedure.

FIGS. 12A to 12D show a tenth liquid extraction device being used to extract liquid from a blood collection tube, at various stages of the liquid extraction procedure.

FIGS. 13A to 13D show an eleventh liquid extraction device being used to extract liquid from a blood collection tube, at various stages of the liquid extraction procedure.

FIGS. 14A to 14D show a twelfth liquid extraction device being used to extract liquid from a blood collection tube, at various stages of the liquid extraction procedure.

FIGS. 15A to 15E show a thirteenth liquid extraction device being used to extract liquid from a blood collection tube, at various stages of the liquid extraction procedure.

FIGS. 16A to 16D show a fourteenth liquid extraction device being used to extract liquid from a blood collection tube, at various stages of the liquid extraction procedure.

FIG. 17A shows a first implementation of a plasma separation membrane configured for use with the liquid extraction devices in FIGS. 3A to 16D.

FIG. 17B shows a second implementation of a plasma separation membrane configured for use with the liquid extraction devices in FIGS. 3A to 16D.

FIG. 17C shows a third implementation of a plasma separation membrane configured for use with the liquid extraction devices in FIGS. 3A to 16D.

FIG. 17D shows a fourth implementation of a plasma separation membrane configured for use with the liquid extraction devices in FIGS. 3A to 16D.

FIG. 18 shows the blood collection tube being inserted into a liquid extraction device in a vertical orientation.

### DETAILED DESCRIPTION

Implementations of the present disclosure are explained below with particular reference to extracting liquid from a blood collection tube. It will be appreciated, however, that the implementations described herein may also be used to extract liquid from other sealed liquid storage containers into which a liquid collection interface (such as a needle) may be inserted.

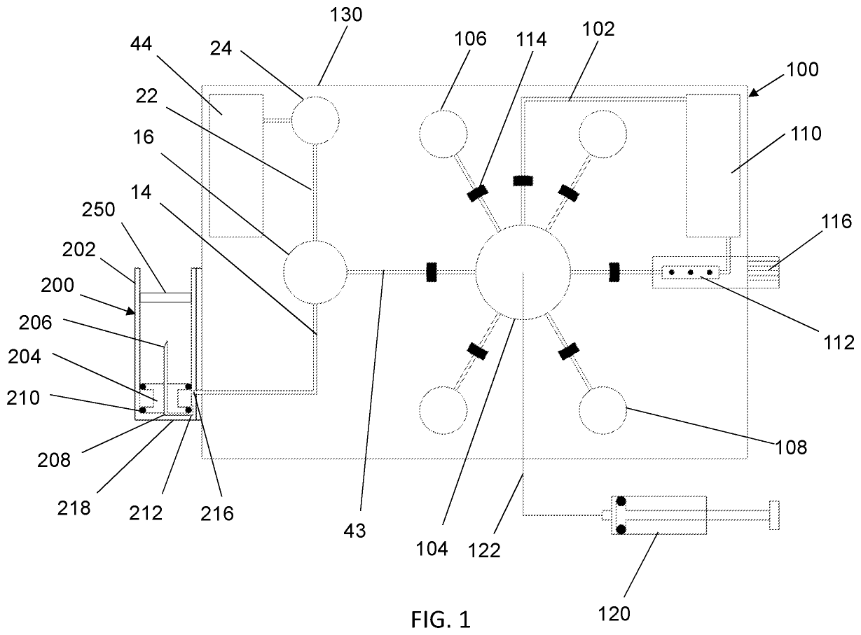

FIG. 1 is a schematic diagram showing a first liquid extraction device 200 in fluidic communication with a liquid handling device in the form of a cartridge 100. As shown in FIG. 1 the cartridge 100 includes a plurality of chambers in fluidic communication via a plurality of conduits 102. Specifically, the plurality of chambers includes a main chamber 104, a reagent chamber 106, a mixing chamber 108, a waste chamber 110, and a measurement chamber 112. The cartridge 100 also includes a plurality of valves 114, each of which controls fluid flow through a respective conduit 102. A sensor 116 is used to carry out a measurement (e.g. an electrochemical measurement) on a solution within the measurement chamber 112.

The flow of fluids between the chambers is controlled by an external pump 120 that is configured to apply a positive or negative pressure to the main chamber 104 via a pump conduit 122. The positive or negative pressure dispenses or aspirates fluid from one chamber to another, depending on which of the valves 114 is opened. For example, to aspirate reagent from the reagent chamber 106 to the main chamber 104 (e.g. for mixing with a sample), the valve 114 between the reagent chamber 106 and the main chamber 104 is opened, and a negative pressure is applied to the main chamber 104 by the pump 120.

The liquid extraction device 200 is in fluidic communication with the cartridge 100 via an inlet conduit 14. As explained in further detail below, the liquid extraction device 200 is configured to extract a liquid sample (e.g. blood) from a pierceable liquid storage container (e.g. a blood collection tube, not shown in FIG. 1). Once the liquid sample has been extracted from the liquid storage container, the liquid sample is transferred under pressure to a metering chamber 16 via the inlet conduit 14. The liquid sample can then be subsequently aspirated from the metering chamber 16 into the main chamber 104 via an outlet conduit 43, by application of a negative pressure using the pump 120.

The sample can then be combined with one or more reagents in the main chamber 104 by aspirating a reagent from the reagent chamber 106 to the main chamber 104. In order to mix the sample and reagent together, the solution may be repeatedly transferred between the main chamber 104 and the mixing chamber 108. The solution may then be dispensed to the measurement chamber 112, where an electrochemical measurement is carried out on the solution, using the sensor 116. Any waste solution from the main chamber 104 or the measurement chamber 112 may be transferred to the waste chamber 110.

As described in more detail below, the liquid extraction device 200 comprises a receptacle in the form of a cylinder 202 (or tube) in which a pierceable liquid storage container, such as a blood collection tube, is received. The liquid extraction device 200 also includes an actuatable liquid extraction mechanism in the form of a piston 204 that is actuatable within the cylinder 202 from a first liquid extraction mechanism configuration to a second liquid extraction mechanism configuration. In FIG. 1, the piston 204 is shown in the second liquid extraction mechanism configuration.

The liquid extraction device 200 includes a liquid storage container interface (e.g. a blood collection tube interface) in the form of a needle 206 that is fixedly attached to the piston 204. The needle 206 is configured to pierce a liquid storage container (e.g. by piercing a septum of a blood collection tube). The needle 206 comprises a liquid extraction outlet 208 through which liquid extracted from the blood collection tube can flow.

The cylinder 202 also comprises an outlet 216 that allows liquid to be removed from the liquid extraction device 200 once it has been extracted from the blood collection tube. The outlet 216 is in fluidic communication with the inlet conduit 14, thereby allowing liquid to be transferred from the liquid extraction device 200 to the cartridge 100.

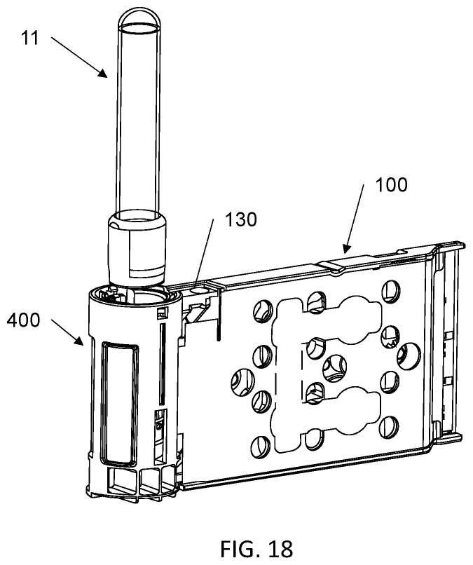

The cartridge 100 further comprises a sample adequacy control chamber 24 that provides a visual indication to a user that a sufficient amount of liquid has been extracted from the liquid storage container (e.g. blood collection tube). In particular, the sample adequacy control chamber 24 may provide a visual indication that a volume of liquid sufficient for a particular diagnostic test has been extracted. As shown, for example, in FIG. 18, the sample adequacy control chamber 24 is configured to provide the visual indication through an optically clear window 130 in a side wall of the cartridge 100 that is disposed upwards when the liquid extraction device 200 is in a vertical orientation (i.e. when the liquid extraction device 200 is used for extracting liquid from the liquid storage container).

The sample adequacy control chamber 24 forms part of a first flow path that is in fluidic communication with an inlet conduit 14 (which receives fluid extracted using the liquid extraction device 200). The cartridge 100 also includes a metering chamber 16 configured to store a specific volume of liquid. The first flow path includes the metering chamber 26, a connector conduit 22 providing a fluidic connection between the metering chamber 16 and the sample adequacy control chamber 24, the sample adequacy control chamber 24, and a vented waste chamber 44 in fluidic communication with the sample adequacy control chamber 24. The cartridge 100 further comprises a second flow path comprising an outlet conduit 43 extending from an outlet port in the metering chamber 16. The outlet conduit 43 allows liquid to be aspirated into the main chamber 104 of the cartridge 100. Alternative implementations may not include the metering chamber 16 or the connector conduit 22, in which case the outlet conduit 43 extends from an outlet port in a sample adequacy control chamber that is configured to meter a specific volume of liquid.

The second flow path (which includes the outlet conduit 43) provides a higher hydraulic resistance than the first flow path (which includes the sample adequacy control chamber 24, and optionally the metering chamber 16 and the outlet conduit 22). This means that the flow rate of liquid through the first flow path is higher than the flow rate through the second flow path. The higher flow rate through the first flow path means that liquid flows into the sample adequacy control chamber 24 to provide the visual indication that a sufficient volume of liquid has been received, without filling the outlet conduit 43.

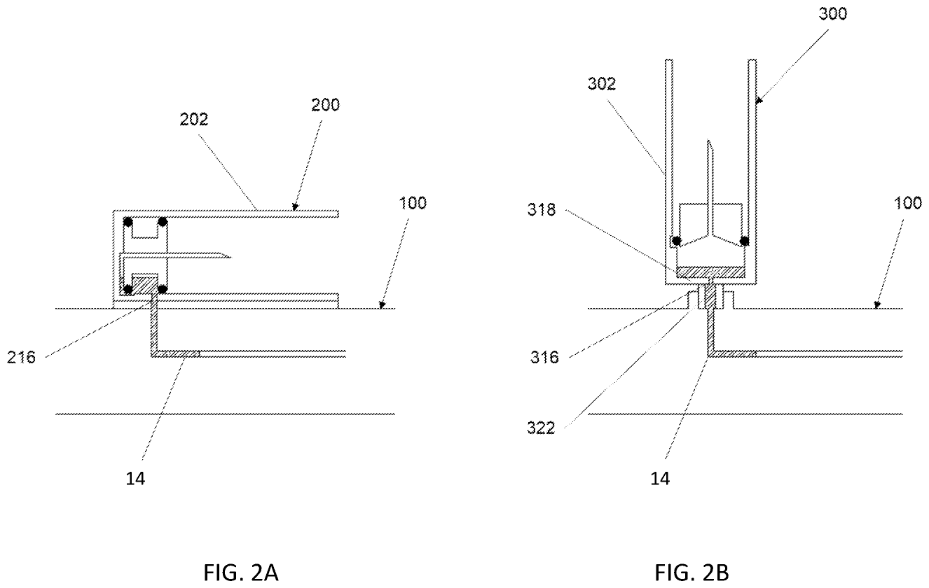

The outlet 216 of the liquid extraction device 200 shown in FIG. 1 is provided in a side wall of the cylinder 202. FIG. 2A shows the attachment between the first liquid extraction device 200 and the cartridge 100 in greater detail. Where the outlet 216 is provided in a side wall of the cylinder 202, the fluidic communication between the liquid extraction device 200 and the cartridge 100 may be provided by aligning the outlet 216 with a hole or via in the cartridge 100 that allows for the passage of fluid into the inlet conduit 14. The alignment of the outlet 216 with the hole or via may be provided by attaching the liquid extraction device 200 to the cartridge 100 using a layer of adhesive (e.g. a pressure-sensitive adhesive).

FIG. 2B shows an alternative attachment of a liquid extraction device to a cartridge, in which a second liquid extraction device 300 is attached to a cartridge (e.g. the cartridge 100). As with the liquid extraction device 200 shown in FIG. 2A, the liquid extraction device 300 comprises a cylinder 302 in which a pierceable liquid storage container, such as a blood collection tube, is received.

The liquid extraction device 300 also comprises a piston 304 that is moveable within the cylinder 302 from a first configuration to a second configuration. Attached to the piston 304 is a liquid storage container interface (e.g. needle 306) that provides a path for air to flow into the liquid storage container, and provides a path for liquid (e.g. blood) to flow out of the liquid storage container.

In contrast to the liquid extraction device 200 shown in FIG. 2A, however, the cylinder 302 comprises an outlet 316 that is provided in an end wall 318 of the cylinder 302. As shown in FIG. 2B, the outlet 316 in the cylinder 302 may be in fluidic communication with a connector 322 that protrudes from the base of the cylinder 302. The connector 322 allows the liquid extraction device 300 to be attached to the cartridge by a push-fit attachment (e.g. by inserting the connector 322 into a corresponding hole or aperture in the cartridge), or using a luer lock, or by any other suitable type of fluidic connector.

It will be appreciated that these attachment mechanisms are not specific to the locations of the outlet in the cylinder of the liquid extraction device. In particular, the liquid extraction device 300 shown in FIG. 2B may be attached to the cartridge using an adhesive, and the liquid extraction device 200 shown in FIG. 2A may comprise a connector protruding from the side wall of the cylinder 202, that allows for attachment to the cartridge 100 using a push-fit or luer lock mechanism, or any other suitable type of fluidic connector. The liquid extraction devices 200, 300 shown in FIGS. 2A and 2B may alternatively be integrated within the cartridge. For example, the cylinders 202, 302 may be moulded (or otherwise manufactured) together with the cartridge 100.

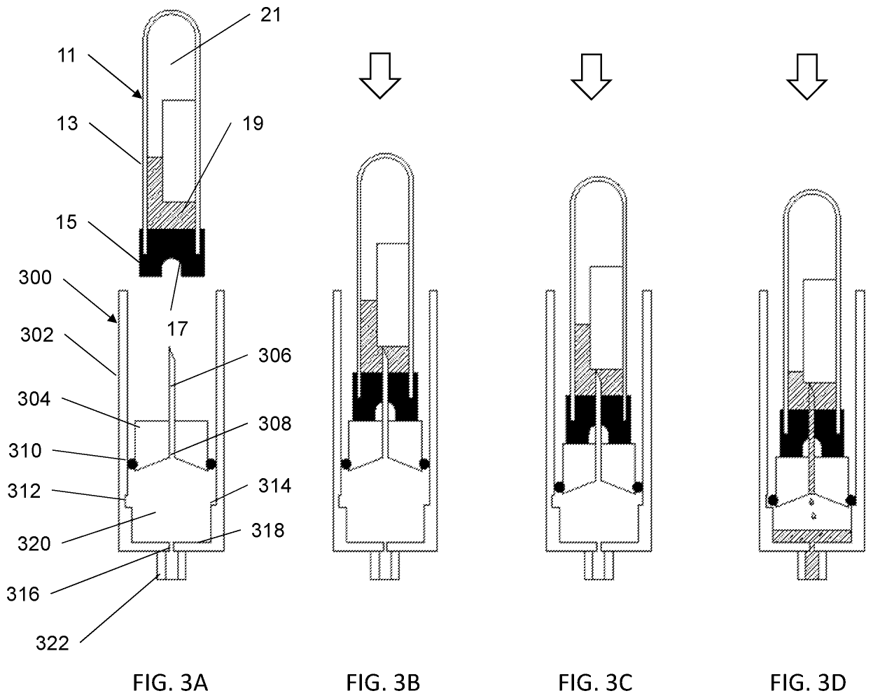

Various implementations of liquid extraction devices that may be used to extract a liquid sample (e.g. blood) from a pierceable liquid storage container (e.g. a blood collection tube) will now be described in greater detail with reference to FIGS. 3A to 17D.

An example of a blood collection tube that may be used with the implementations shown in FIGS. 3A to 17D is shown schematically in FIG. 3A. As shown in FIG. 3A, the blood collection tube 11 comprises a tubular container 13 that is sealed using a cap 15. The cap 15 comprises a septum 17 formed of a deformable material, such as rubber. The septum 17 is pierceable by a needle or cannula, thereby allowing an end of the needle or cannula to pass into an internal volume of the tubular container 13. When the needle or cannula is removed from the septum 17, the deformable material deforms to close the hole pierced by the needle or cannula, thereby re-sealing the container 13. The blood collection tube 11 contains a volume of liquid 19 (e.g. blood) and a headspace including a volume of gas 21. Examples of blood collection tubes 10 include Vacutainers (RTM) manufactured by Becton, Dickinson and Company of Franklin Lakes, NJ, USA.

FIGS. 3A to 3D show the second liquid extraction device 300 (shown in FIG. 2B) being used to extract liquid from the blood collection tube 11. FIG. 3A shows the liquid extraction device 300 prior to attachment of the blood collection tube 11.

As explained with reference to FIG. 2B, the liquid extraction device 300 includes a receptacle in the form of a cylinder 302 (or tube) in which the blood collection tube 11 is received. The liquid extraction device 300 also includes an actuatable liquid extraction mechanism in the form of a piston 304 that is moveable within the cylinder 302. The piston 304 is actuatable within the cylinder 302 from a first configuration (e.g. as shown in FIG. 3B) to a second configuration (e.g. as shown in FIG. 3D). In FIG. 3C, the piston 304 is shown in between the first configuration and the second configuration.

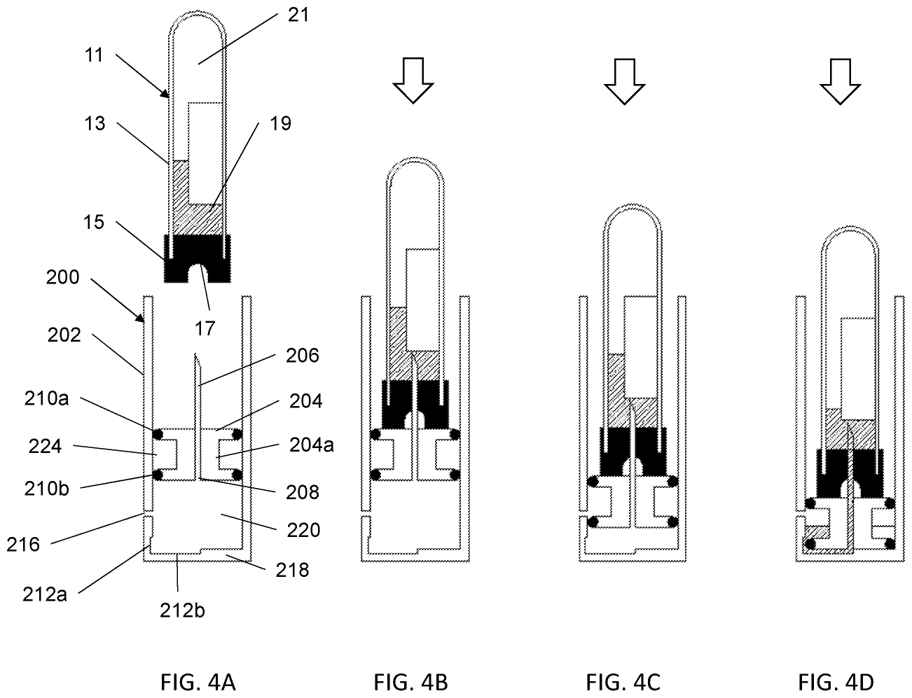

The liquid extraction device 300 also includes a liquid storage container interface configured to provide a fluidic connection to a volume of liquid within the liquid storage container. For example, as shown in this implementation and the implementations described with reference to FIGS. 4A to 17D, the liquid storage container interface may be provided in the form of a blood collection tube interface. In the example shown in FIGS. 3A to 3D, the blood collection tube interface is provided in the form of a needle 306. The needle 306 is fixedly attached to the piston 304, meaning that the needle 306 is moveable with the piston 304 within the cylinder 302. The needle 306 protrudes from the piston 304 and is configured to pierce the septum 17 of the blood collection tube 11, thereby providing a fluidic connection to the volume of liquid 19 within the blood collection tube 11, and providing attachment between the liquid extraction device 300 and the blood collection tube 11. The needle 306 comprises a liquid extraction outlet 308 through which liquid extracted from the blood collection tube 11 can flow.

The piston 304 also comprises a sealing element in the form of an O-ring seal 310 extending around the circumference of the piston 304 at the base of the piston 304. The O-ring seal 310 forms a seal between the piston 304 and the cylinder 302, which prevents air from escaping from within the cylinder 302 when the piston 304 is in the positions shown in FIGS. 3A to 3C. The sealing element could, alternatively, be provided in the form of a moulded plastic seal (i.e. moulded together with the piston 304), or an over-moulded rubber seal.

The cylinder 302 in which the blood collection tube 11 is received comprises an aperture in the form of a recess 312 in an internal side wall of the cylinder 302. The recess 312 extends around at least part of the circumference of the internal side wall of the cylinder 302. The recess 312 provides a path for air to flow around the O-ring seal 310 when the piston 304 is moved to the second configuration shown in FIG. 3D. When the piston 304 is in the second configuration, the O-ring seal 310 is aligned with the recess 312, thereby allowing air to escape around the O-ring seal 310. Consequently, the sealing provided by the O-ring seal 310 is compromised when the O-ring seal 310 is aligned with the recess 312 (i.e. when the piston 304 is in the second configuration).

The cylinder 302 also comprises a stop 314 that protrudes from the internal side wall of the cylinder 302. The stop 314 extends around at least part of the circumference of the internal wall. The stop 314 prevents downward movement of the piston 304 within the cylinder 302 beyond the point at which the stop 314 protrudes. The stop 314 is provided to align the O-ring seal 310 of the piston 304 with the recess 312 in the cylinder 302. In particular, when the piston 304 abuts the stop 314, the O-ring seal 310 is aligned with the recess 312 such that air is able to flow around the O-ring seal 310 via the recess 312. In the example shown in FIGS. 3A to 3D, the stop 314 is provided by a reduction in the cross-sectional area of the internal volume of the cylinder 302. It will be appreciated, however, that the stop 314 may alternatively be provided in the form of a protrusion extending from the internal side wall of the cylinder 302.

The cylinder 302 also comprises an outlet 316 that allows liquid to be removed from the liquid extraction device 300 once it has been extracted from the blood collection tube 11. The outlet 316 may, for example, be in fluidic communication with a liquid handling device such as a diagnostic cartridge (e.g. a microfluidic cartridge). Alternatively or additionally, the outlet 316 may comprise a valve allowing liquid to be extracted from the cylinder 302 via the outlet 316. The outlet 316 may alternatively comprise a seal that is pierced, ruptured or torn when the liquid extraction device 300 is attached to a cartridge. In the example shown in FIGS. 3A to 3D, the outlet 316 is located in an end wall 318 of the cylinder 302, and is in fluidic communication with a connector 322 that provides for attachment of the liquid extraction device 300 to a cartridge.

Together, the cylinder 302 and the piston 304 define an unvented chamber 320 between the piston 304 and the end wall 318 of the cylinder 302. The liquid extraction outlet 308 is in fluidic communication with the chamber 320. The volume of the chamber 320 is reduced as the piston 304 is moved towards the end wall 318 of the cylinder 302 (i.e. as the piston 304 is moved from the first configuration to the second configuration). The stop 314 defines a minimum volume of the chamber 320.

When the blood collection tube 11 is attached to the liquid extraction device 300 via the needle 306, the chamber 320 is in fluidic communication with the volume of liquid 19 via the needle 306.

The procedure for extracting liquid from the blood collection tube 11 is shown in FIGS. 3A to 3D. As described in more detail below, a pressure difference between the volume of gas 21 within the blood collection tube 11 and the liquid extraction outlet 308 is generated when the piston 304 is moved from the first configuration to the second configuration. Specifically, in the example shown in FIGS. 3A to 3D, the pressure difference is generated once the piston 304 is in the second configuration.

FIG. 3A shows the blood collection tube 11 disconnected from the liquid extraction device 300. To attach the blood collection tube 11 to the liquid extraction device 300, a user forces the blood collection tube 11 downwards onto the needle 306, so that the needle 306 pierces the septum 17. At this point, shown in FIG. 3B, the needle 306 provides fluidic communication between the volume of liquid 19 and the chamber 320. In the position shown in FIG. 3B (i.e. when the piston 304 is in the first configuration), there is no pressure difference between the volume of gas 21 and the liquid extraction outlet 308.

Application of further downward force on the blood collection tube 11 by the user displaces the piston 304 within the cylinder 302, which reduces the volume of the chamber 320, as shown in FIG. 3C. Given that the chamber 320 is unvented, the reduction in volume of the chamber 320 increases the pressure of the air within the chamber 320 above atmospheric pressure, because the O-ring seal 310 prevents the escape of air from the chamber 320. This means that air is forced into the blood collection tube 11 via the needle 306, which increases the pressure of the volume of gas 21 within the blood collection tube 11.

Further downward movement of the piston 304 by continued application of a downward force results in a further increase in pressure of the air within the chamber 320 and the blood collection tube 11, until the piston 304 reaches the second configuration, shown in FIG. 3D. Once the piston 304 is in the second configuration, the O-ring seal 310 is aligned with the recess 312, and is consequently compromised, allowing air to escape around the O-ring seal 310 via the recess 312. This means that the higher pressure air within the chamber 320 vents to the atmosphere. At this point, there is a pressure difference between the volume of gas 21 in the blood collection tube 11 and the liquid extraction outlet 308. Specifically, the pressure of the volume of gas 21 within the blood collection tube 11 is higher than the pressure at the liquid extraction outlet 308 (which is at the same pressure as the chamber 320, i.e. atmospheric pressure). The difference in pressure between the volume of gas 21 in the blood collection tube 11 and the liquid extraction outlet 308 forces liquid through the needle 306 and into the chamber 320 via the liquid extraction outlet 308.

The venting of the chamber 320 allows the extracted liquid to be aspirated into a chamber of a cartridge to which the liquid extraction device 300 is attached (e.g. by a pump in fluidic communication with a chamber of the cartridge, as described with reference to FIG. 1). Alternatively, the extraction of liquid from the blood collection tube 11 may be carried out when the liquid extraction device 300 is not attached to a cartridge. In this case, the liquid extraction device 300 may then be subsequently attached to a cartridge so that the extracted liquid can be aspirated into a chamber of the cartridge.

Once liquid has been extracted from the blood collection tube 11, the blood collection tube 11 may be disconnected from the liquid extraction device 300 by application of an upwards force on the blood collection tube 11. This causes the needle 306 to be withdrawn from the septum 17, causing the septum 17 to be re-sealed.

FIGS. 4A to 4D show the first liquid extraction device 200 being used to extract liquid from the blood collection tube 11. FIG. 4A shows the liquid extraction device 200 prior to attachment of the blood collection tube 11. The liquid extraction device 200 allows liquid to be extracted from an outlet 216 in a side wall of the cylinder 202 of the liquid extraction device 200.

As with the second liquid extraction device 300 shown in FIGS. 3A to 3D, the liquid extraction device 200 shown in FIGS. 2A to 2D includes an actuatable liquid extraction mechanism in the form of a piston 204 that is actuatable within a cylinder 202 from a first configuration (FIG. 2B) to a second configuration (FIG. 2D). FIG. 2C shows the piston 204 in between the first configuration and the second configuration.

The liquid extraction device 200 includes a liquid storage container interface (e.g. a blood collection tube interface) in the form of a needle 206 that is fixedly attached to the piston 204 and has the functionality of the needle 306 shown in FIGS. 3A to 3D. The needle 206 comprises a liquid extraction outlet 208 through which liquid extracted from the blood collection tube 11 can flow.

In contrast to the liquid extraction device 300 shown in FIGS. 3A to 3D, the liquid extraction device 200 comprises a first sealing element in the form of a first O-ring seal 210a, and a second sealing element in the form of a second O-ring seal 210b. The first O-ring seal 210a extends around the circumference of the piston 204 at the top of the piston 204. The second O-ring seal 210b extends around the circumference of the piston 204 at the base of the piston 204. Each O-ring seal 210a, 210b forms a seal between the piston 204 and the cylinder 202.

As shown in FIGS. 4A to 4D, the piston 204 comprises a piston section 204a located in between the O-ring seals 210a, 210b. The cross-section of the piston section 204a is smaller than the cross-section of the piston portions to which the O-ring seals 210a, 210b are attached. The narrower piston section 204a provides a reservoir 224 between the piston 204 and the side walls of the cylinder 202. The reservoir 224 is brought into fluidic communication with the liquid extraction outlet 208 once the second O-ring seal 210b is compromised (as described below).

The cylinder 202 comprises an aperture in the form of a first recess 212a that extends around at least part of the circumference of the internal side wall of the cylinder 202. The first recess 212a is in fluidic communication with a second recess 212b provided in an end wall 218 of the cylinder 202. The second recess 212b extends across a portion of the end wall 218 so as to be in fluidic communication with the liquid extraction outlet 208 when the piston 204 is in the second configuration.

The first recess 212a provides a path for air to flow around the second O-ring seal 210b and into the reservoir 224, when the piston 204 is moved to the second configuration shown in FIG. 2D. When the piston 204 is in the second configuration, the second O-ring seal 210b is aligned with the first recess 212a, thereby allowing air to escape around the second O-ring seal 210b.

The recesses 212a, 212b also provide a path for liquid to flow around the second O-ring seal 210b and into the reservoir 224. In particular, when the piston 204 is in the second configuration, the second O-ring seal 210b is aligned with the first recess 212a, allowing air to flow around the second O-ring seal 210b and into the reservoir 224. Liquid can then flow out of the liquid extraction outlet 208 and into the reservoir 224 via the first and second recesses 212a, 212b.

The end wall 218 of the cylinder 202 provides a stop to prevent further downward movement of the piston 204. When the piston 204 is in contact with the end wall 218, the second O-ring seal 210b is aligned with the first recess 212a (as shown in FIG. 4D).

The cylinder 202 also comprises an outlet 216 in a side wall of the cylinder 202. The outlet 216 is aligned with the reservoir 224 when the piston 204 is in the second configuration (as shown in FIG. 4D).

Together, the cylinder 202 and the piston 204 define an chamber 220 between the piston 204 and the end wall 218 of the cylinder 202. The liquid extraction outlet 208 is in fluidic communication with the chamber 220. The volume of the chamber 220 is reduced as the piston moves from the first configuration to the second configuration. Initially, when the piston 204 is in the first configuration, shown in FIG. 4B, the chamber 220 is vented via the outlet 216. As the piston 204 moves past the outlet 216, the chamber 220 becomes unvented (as shown in FIG. 4C).

The liquid extraction device 200 shown in FIGS. 4A to 4D extracts liquid from the blood collection tube 11 in a similar manner to the liquid extraction device 300 shown in FIGS. 3A to 3D. In particular, a pressure difference is generated between the volume of gas 21 within the blood collection tube 11 and the liquid extraction outlet 208 when the piston is moved from the first configuration to the second configuration. Specifically, this pressure difference is generated once the piston 204 is in the second configuration.

The blood collection tube 11 is attached to the liquid extraction device 200 in the same manner as for the liquid extraction device 300 shown in FIGS. 3A to 3D. Once the blood collection tube 11 is attached, application of a downward force reduces the volume of the chamber 220. Initially, when the piston 204 is in the position shown in FIG. 4B, downward movement of the piston 204 causes air to be displaced from the chamber 220 and expelled out of the outlet 216 (e.g. to a vented cartridge). However, once the piston 204 is displaced past the outlet 216, the reduction in volume of the chamber 220 pressurises the air in the chamber 220, thereby forcing air through the needle 206 and into the blood collection tube 11 (FIG. 4C). This increases the pressure of the volume of gas 21 within the blood collection tube 11.

Further downward movement of the piston 204 results in a further increase in pressure of the volume of gas 21, until the piston 204 reaches the second configuration (FIG. 4D). In the second configuration, the second O-ring seal 210b is aligned with the first recess 212a. This allows air from the chamber 220 (which now has a very small volume) to escape around the second O-ring seal 210b via the first recess 212a, and through the outlet 216. At this point, the chamber 220 and the liquid extraction outlet 208 are at atmospheric pressure, whereas the volume of gas 21 is above atmospheric pressure. This pressure difference forces liquid through the needle 206 and into the reservoir 224 via the liquid extraction outlet 208 and the recesses 212a, 212b.

Once the blood collection tube 11 is disconnected from the liquid extraction device 200, the reservoir 224 is vented via the needle 206. The extracted liquid can then be aspirated from the reservoir 224 into a chamber of a cartridge.

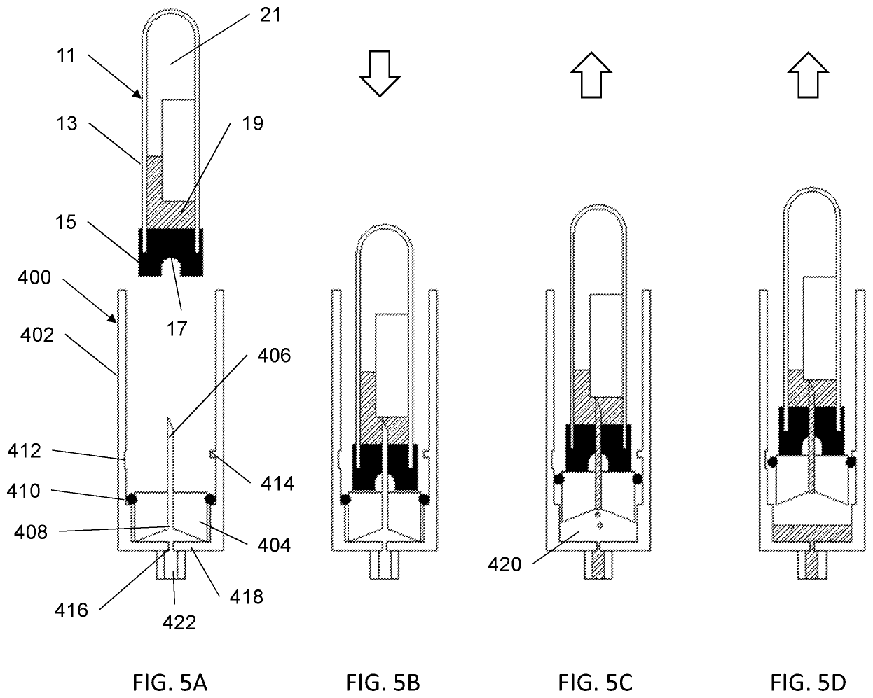

FIGS. 5A to 5D show a third liquid extraction device 400 being used to extract liquid from the blood collection tube 11. FIG. 5A shows the liquid extraction device 400 prior to attachment of the blood collection tube 11. The liquid extraction device 400 allows liquid to be extracted by generating a negative pressure within a chamber 420 of the liquid extraction device 400.

The liquid extraction device 400 includes a cylinder 402 (or tube) in which the blood collection tube 11 is received. The liquid extraction device 400 also includes an actuatable liquid extraction mechanism in the form of a piston 404, and a liquid storage container interface (e.g. a blood collection tube interface) in the form of a needle 406 having a liquid extraction outlet 408, each having the same functionality as the piston 304 and needle 306 of the liquid extraction device 300 shown in FIGS. 3A to 3D. However, in contrast to the piston 304 of the liquid extraction device 300 shown in FIGS. 3A to 3D, the piston 404 shown in FIGS. 5A to 5D comprises a sealing element in the form of an O-ring seal 410 extending around the circumference of the piston 404 at the top of the piston 404.

As with the liquid extraction device 300 shown in FIGS. 3A to 3D, the cylinder 404 of the liquid extraction device 400 shown in FIGS. 5A to 5D comprises an outlet 416 provided in an end wall 418 of the cylinder 402. The outlet 416 is in fluidic communication with a connector 422. In addition, the cylinder 402 comprises a recess 412 extending around at least part of the circumference of the internal side wall of the cylinder 412. The recess 412 provides a path for air flow around the O-ring seal 410 when the O-ring seal 410 is aligned with the recess 412.

The cylinder 402 also comprises a stop 414 in the form of a protrusion extending from the internal side wall of the cylinder 402. The stop 414 extends around at least part of the circumference of the internal wall of the cylinder 402 and prevents upward movement of the piston 404 within the cylinder 402 beyond the point at which the stop 414 protrudes. The stop 414 is provided to align the O-ring seal 410 of the piston 404 with the recess 412 when the piston 404 abuts the stop 414.

The piston 404 and cylinder 402 together define an unvented chamber 420 (as best shown in FIG. 5C) between the piston 404 and the end wall 418 of the cylinder 402. In contrast to the chamber 320 of the liquid extraction device 300 shown in FIGS. 3A to 3D, the volume of the chamber 420 shown in FIGS. 5A to 5D is increased as the piston 404 is moved away from the end wall 418 of the cylinder 402. The stop 414 defines a maximum volume of the chamber 420.

The procedure for extracting liquid from the blood collection tube 11 is shown in FIGS. 5A to 5D. As with the implementations described above, liquid is extracted by generating a pressure difference between the volume of gas 21 within the blood collection tube 11 and the liquid extraction outlet 408 when the piston 404 is moved from the first configuration to the second configuration. In the implementation shown in FIGS. 5A to 5D, the pressure difference is generated during actuation of the piston 404 from the first configuration to the second configuration.

The blood collection tube 11 is attached to the liquid extraction device 400 in the same manner as in the above implementations. Once attached, as shown in FIG. 4B (i.e. with the piston 404 in the first configuration), there is no pressure difference between the volume of gas 21 and the liquid extraction outlet 408.

Application of an upward force on the blood collection tube 11 by the user displaces the piston 404 within the cylinder 402, which increases the volume of the chamber 420, as shown in FIG. 5C. Given that the chamber 420 is unvented, the increase in volume of the chamber 420 reduces the pressure of the air within the chamber 420 below atmospheric pressure, because the O-ring seal 410 prevents the escape of air from the chamber 420. This means that there is a pressure difference between the volume of gas 21 within the blood collection tube 11 (which is at atmospheric pressure) and the liquid extraction outlet 408 into the chamber 420 (which is below atmospheric pressure). This pressure difference forces liquid through the needle 406 and into the chamber 420 via the liquid extraction outlet 408.

Further upward movement of the piston 404 by continued application of an upward force results in a further reduction in pressure of the air within the chamber 420 and the blood collection tube 11, thereby drawing more liquid out of the blood collection tube 11. This continues until the piston 404 reaches the second configuration, shown in FIG. 5D. Once the piston 404 is in the second configuration, the O-ring seal 410 is aligned with the recess 412, and is consequently compromised, allowing air to escape around the O-ring seal 410 via the recess 412. This means that the chamber 420 vents to the atmosphere, thereby equalising the pressure between the chamber 420 and the volume of gas 21 in the blood collection tube 11. The equalisation of the pressure between the chamber 420 (and liquid extraction outlet 408) and the volume of gas 21 stops the flow of liquid into the chamber 420. The venting of the chamber 420 allows liquid to be aspirated into a chamber of a cartridge. The blood collection tube 11 can then be disconnected from the liquid extraction device 400.

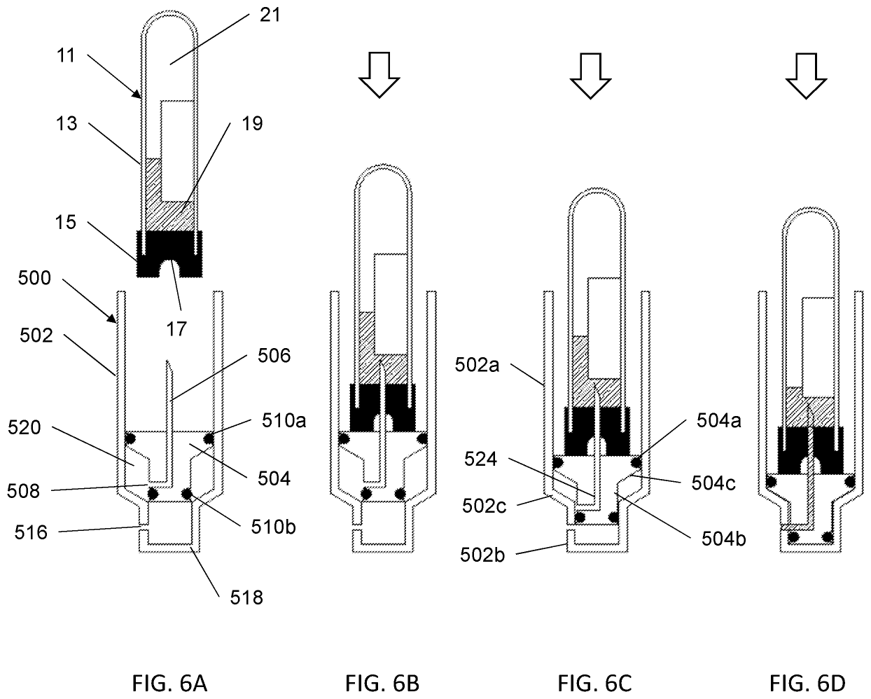

FIGS. 6A to 6D show a fourth liquid extraction device 500 being used to extract liquid from the blood collection tube 11. FIG. 6A shows the liquid extraction device 500 prior to attachment of the blood collection tube 11. The liquid extraction device 500 generates a pressure difference between a chamber 520 provided between a piston 504 and a side wall of a cylinder 502.

As with the implementations described above, the liquid extraction device 500 comprises an actuatable liquid extraction mechanism (piston 504) moveable within a cylinder 502 from a first configuration (FIG. 6B) to a second configuration (FIG. 6D).

In the example shown in FIGS. 6A to 6D, the cylinder 502 comprises a first cylindrical portion 502a having a first cross-section, a second cylindrical portion 502b having a second cross-section smaller than the first cross-section, and a tapering portion 502c in between the first cylindrical portion 502a and the second cylindrical portion 502b (illustrated in FIG. 6C). In the tapering portion 502c, the cross-section of the cylinder 502 reduces from the first cross-section to the second cross-section.

Likewise, the piston 504 comprises a first cylindrical piston portion 504a having a first cross-section, a second cylindrical piston portion 504b having a second cross-section smaller than the first cross-section, and a tapering piston portion 504c in between the first cylindrical piston portion 504a and the second cylindrical piston portion 504b (illustrated in FIG. 6C). In the tapering piston portion 504c, the cross-section of the piston 504 reduces from the first cross-section to the second cross-section. The cross-section of the first cylindrical piston portion 504a is in between the cross-section of the first cylindrical portion 502a and the second cylindrical portion 502b. The cross-section of the second cylindrical piston portion 504b is smaller than the cross-section of the second cylindrical portion 502b such that the second cylindrical piston portion 504b is moveable within the second cylindrical portion 502b.

As with the implementations described above, the liquid extraction device 500 includes a liquid storage container interface (e.g. a blood collection tube interface) in the form of a needle 506, having a liquid extraction outlet 508. In the example shown in FIGS. 6A to 6D, the liquid extraction outlet 508 is provided in a side wall of the piston 504 (specifically, in a side wall of the second cylindrical piston portion 504b). Consequently, the piston 504 includes an L-shaped channel 524 (illustrated in FIG. 6C) that connects the end of the needle 506 protruding from the piston 504 and the liquid extraction outlet 508.

The piston 504 also comprises sealing elements in the form of a first O-ring seal 510a extending around the circumference of the piston 504 at the top of the piston 504 (specifically, around the top of the first cylindrical piston portion 504a), and a second O-ring seal 510b extending around the circumference of the piston 504 at the base of the piston 504 (specifically, around the base of the second cylindrical piston portion 504b). The O-ring seals 510a, 510b form a seal between the piston 504 and the cylinder 502, which prevents air from escaping from within the cylinder 502 when the piston 504 is in the positions shown in FIGS. 6A to 6C. Specifically, the first O-ring seal 510a forms a seal between the first cylindrical piston portion 504a and the first cylinder portion 502a, and the second O-ring seal 510b forms a seal between the second cylindrical piston portion 504b and the second cylinder portion 502b.

The cylinder 502 also comprises an outlet 516 that allows liquid to be removed from the liquid extraction device 500 once it has been extracted from the blood collection tube 11. In the example shown in FIGS. 6A to 6D, the outlet 516 is located in a side wall of the cylinder 502 (specifically, in a side wall of the second cylindrical portion 502b). The outlet 516 also acts as an aperture that compromises the sealing provided by the second O-ring seal 510b.

Together, the cylinder 502 and the piston 504 define an unvented chamber 520 between the piston 504 and the internal side walls of the cylinder 502. When the piston 504 is in the position shown in FIG. 6C, the O-ring seals 510a, 510b prevent air from escaping from the chamber 520. The volume of the chamber 520 is reduced as the piston 504 is moved towards an end wall 518 of the cylinder 502 (i.e. as the piston 504 is moved from the first configuration to the second configuration).

The end wall 518 is provided at the end of the second cylinder portion 502b. The end wall 518 defines a stop that provides an extent of movement of the piston 504. When the piston 504 abuts the end wall 518, the liquid extraction outlet 508 is aligned with the outlet 516 in the cylinder 502. Any air in the region between the end wall 518 and the base of the piston 504 escapes through the outlet 516 as the piston 504 is displaced downwardly (i.e. as the piston 504 is moved from the position shown in FIG. 6B to the position shown in FIG. 6C).

The procedure for extracting liquid from the blood collection tube 11 is similar to the procedure for the liquid extraction devices 200, 300 described above, and is shown in FIGS. 6A to 6D. That is, a pressure difference between a volume of gas 21 within the blood collection tube 11 and the liquid extraction outlet 508 is generated when the piston 504 is moved from the first configuration to the second configuration. Specifically, in the example shown in FIGS. 6A to 6D, the pressure difference is generated once the piston 504 is in the second configuration.

The blood collection tube 11 is attached to the liquid extraction device 500 in the same manner as in the above implementations. Once attached, application of a downward force on the blood collection tube 11 by the user displaces the piston 504 within the cylinder 502, which reduces the volume of the chamber 520, as shown in FIG. 5C. The reduction in volume of the chamber 520 pressurises the chamber 520 and forces air through the needle 506 via the L-shaped channel 524, and into the blood collection tube 11 (FIG. 6C). This increases the pressure of the volume of gas 21 within the blood collection tube 11.

Further downward movement of the piston 504 results in a further increase in pressure of the volume of gas 21, until the piston 504 reaches the second configuration, shown in FIG. 6D. Once the piston 504 is in the second configuration, the liquid extraction outlet 508 is aligned with the outlet 516, which acts as an aperture to compromise the sealing of the chamber 520 provided by the second O-ring seal 510b, thereby allowing any air remaining in the chamber 520 to escape via the outlet 516. At this point, the pressure of the volume of gas 21 within the blood collection tube 11 is higher than the pressure at the liquid extraction outlet 508 (which is at atmospheric pressure). This pressure difference forces liquid through the needle 506 and out of the liquid extraction device 500 via the L-shaped channel 524 and the liquid extraction outlet 508. For example, the liquid may be forced into a chamber of a cartridge via the liquid extraction outlet 508. The blood collection tube 11 can then be disconnected from the liquid extraction device 500.

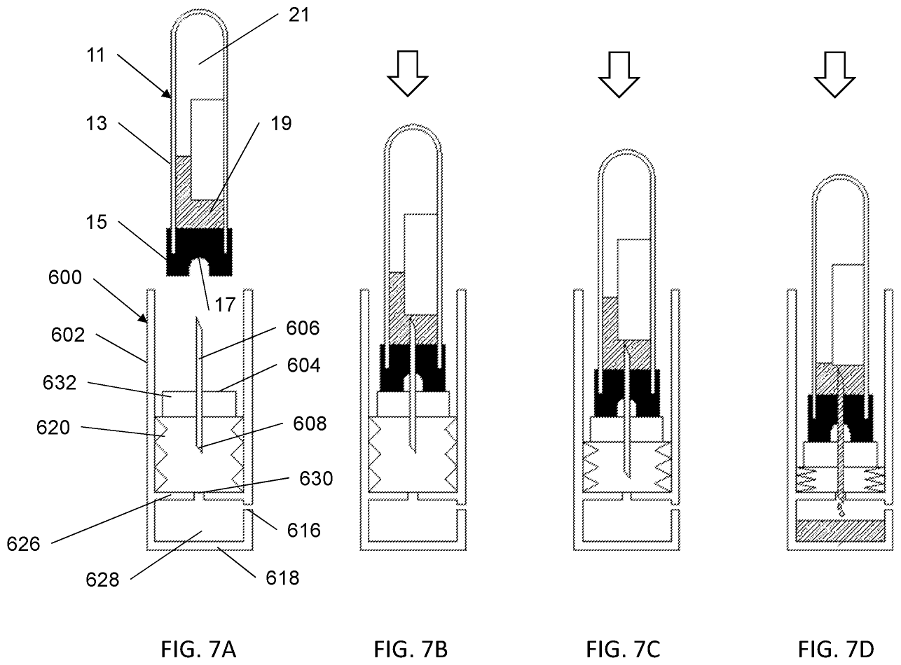

FIGS. 7A to 7D show a fifth liquid extraction device 600 being used to extract liquid from the blood collection tube 11. FIG. 7A shows the liquid extraction device 600 prior to attachment of the blood collection tube 11. The liquid extraction device 600 includes a separate vented chamber from which extracted liquid can be aspirated.

As with the above implementations, the liquid extraction device 600 includes a cylinder 602 (or tube) in which the blood collection tube 11 is received. The liquid extraction device 600 also includes an actuatable liquid extraction mechanism in the form of a piston 604, and a liquid storage container interface (e.g. a blood collection tube interface) in the form of a needle 606 having a liquid extraction outlet 608.

The cylinder 602 includes a dividing wall 626 that extends across the cross-section of the cylinder 602. The dividing wall 626 defines a distinct chamber 628 within the cylinder 602. Specifically, the chamber 628 is defined between an end wall 618 of the cylinder 602 and the dividing wall 626. As with the above implementations, the cylinder 602 includes an outlet 616 that allows liquid to be removed from the liquid extraction device 600. The outlet 616 is provided in a side wall of the cylinder 602, and is in fluidic communication with the chamber 628. The outlet 616 may be vented (e.g. by connection to a vented cartridge), meaning that the chamber 628 is at atmospheric pressure.

The dividing wall 626 further includes a sealed aperture 630 (e.g. at the centre of the dividing wall 626). The sealed aperture 630 is pierceable, such that the aperture 630 provides a fluidic connection into the chamber 628 once pierced.

The piston 604 comprises a support 632 attached to a deformable element in the form of an unvented bellows chamber 620. The bellows chamber 620 is disposed between the support 632 and the dividing wall 626. The bellows chamber 620 has concertinaed sides that allow the volume of the bellows chamber 620 to be reduced from a first volume shown in FIG. 7B (i.e. when the piston 604 is in a first configuration) to a reduced volume shown in FIG. 7D (i.e. when the piston 604 is in a second configuration).

The needle 606 is mounted within the support 632. The liquid extraction outlet 608 extends partly into the bellows chamber 620, and is configured to pierce the sealed aperture 630 in the dividing wall 626 when the piston 604 is actuated to the second configuration. The needle 606 and the liquid extraction outlet 608 may, for example, be provided in the form of a double-ended needle that extends through the support 632.

The procedure for extracting liquid from the blood collection tube 11 is shown in FIGS. 7A to 7D. As with the implementations described above, liquid is extracted by generating a pressure difference between the volume of gas 21 within the blood collection tube 11 and the liquid extraction outlet 608 when the piston 604 is moved from the first configuration to the second configuration. In the implementation shown in FIGS. 7A to 7D, the pressure difference is generated once the piston 604 is in the second configuration.

The blood collection tube 11 is attached to the liquid extraction device 600 in the same manner as in the above implementations. Once attached, as shown in FIG. 4B (i.e. with the piston 604 in the first configuration), there is no pressure difference between the volume of gas 21 and the liquid extraction outlet 608.

Downward movement of the piston 604 results in a reduction in volume of the bellows chamber 620. As the bellows chamber 620 is unvented, the reduction in volume increases the air pressure within the bellows chamber 620 and forces air into the blood collection tube 11 via the needle 606. This increases the pressure of the volume of gas 21 within the blood collection tube 11.

Further downward movement of the piston 604 results in a further increase in pressure of the volume of gas 21, until the piston 604 reaches the second configuration (FIG. 7D). In the second configuration, the liquid extraction outlet 608 pierces the sealed aperture 630, bringing the liquid extraction outlet 608 into fluidic communication with the chamber 628, which is at atmospheric pressure. Therefore, there is a pressure difference between the liquid extraction outlet 608 (at atmospheric pressure) and the volume of gas 21. This pressure difference forces liquid through the needle 606 and into the chamber 628 via the liquid extraction outlet 608.

Once the blood collection tube 11 is disconnected from the liquid extraction device 600, the chamber 628 is vented via the aperture 630 and the needle 606. The extracted liquid can then be aspirated from the chamber 628 of the liquid extraction device 600 into a chamber of a cartridge.

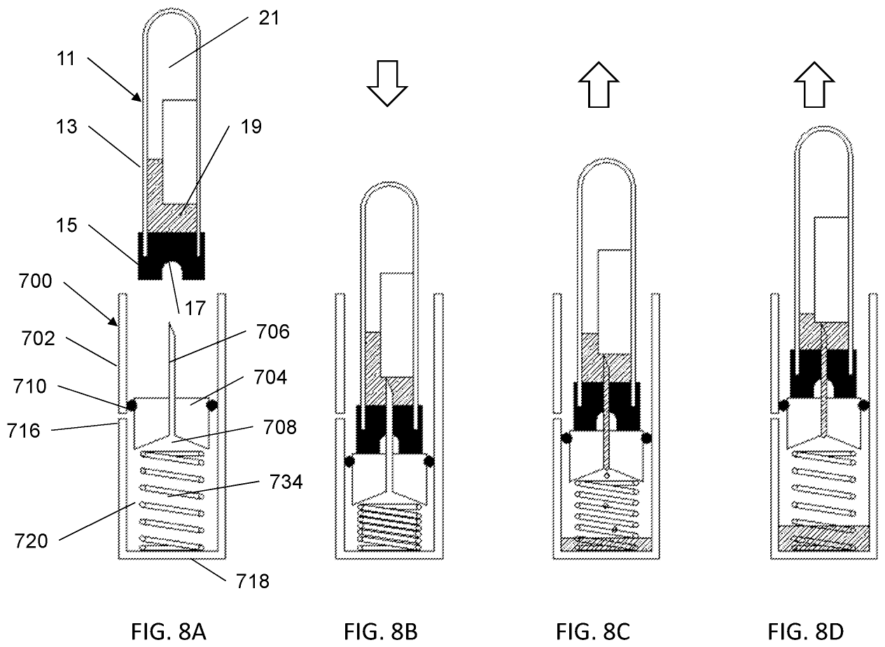

FIGS. 8A to 8D show a sixth liquid extraction device 700 being used to extract liquid from the blood collection tube 11. FIG. 8A shows the liquid extraction device 700 prior to attachment of the blood collection tube 11. The liquid extraction device 700 is used to pressurise the volume of gas 21 within the blood collection tube 11 and to subsequently generate a pressure difference between the volume of gas 21 and a liquid extraction outlet 708. The liquid extraction device 700 includes a resiliently deformable element that slows the rate of change of pressure when generating the pressure difference (when compared with the pressure difference generated using the liquid extraction devices 200, 300, 500). Using a slower rate of change of pressure may reduce haemolysis, which may occur during the rapid flow of blood when a pressure change is generated instantaneously. The resiliently deformable element also allows for a controlled change in pressure, because the rate of change of pressure is defined by the resiliently deformable element, and not by application of an upwards force on the piston by the user (as with the liquid extraction device 400).

The liquid extraction device 700 comprises an actuatable liquid extraction mechanism in the form of a piston 704 moveable within a cylinder 702 from a first configuration (FIG. 8B) to a second configuration (FIG. 8D). The liquid extraction device 700 also includes a liquid storage container interface (e.g. a blood collection tube interface) in the form of a needle 706 having a liquid extraction outlet 708. The piston 704 comprises a sealing element in the form of an O-ring seal 710 extending around the circumference of the piston 704 at the top of the piston 704. The O-ring seal 710 provides a seal between the cylinder 702 and the piston 704.

The cylinder 702 also includes an outlet 716 that allows liquid extracted from the blood collection tube 11 to be removed from the liquid extraction device 700. The outlet 716 is provided in a side wall of the cylinder 702.

Together, the piston 704 and the cylinder 702 define a chamber 720. In particular, the chamber 720 is defined within the cylinder 702 between an end wall 718 of the cylinder 702 and the piston 704. The liquid extraction device 700 further includes a resiliently deformable element (shown in FIGS. 8A to 8D in the form of a spring 734) disposed within the chamber 720. When compressed, the spring 734 biases the piston 704 away from the end wall 718 of the cylinder 702.

The chamber 720 is vented when the blood collection tube 11 is initially attached to the liquid extraction device 700 (i.e. when the piston 704 is in the position shown in FIG. 8A), and when the spring 734 returns the piston 704 to its starting position (i.e. the second configuration, shown in FIG. 8D). Once the piston 704 is actuated past the outlet 716 in the side wall of the cylinder 702, the chamber 720 is unvented (i.e. in the positions shown in FIGS. 8B and 8C).

The procedure for extracting liquid from the blood collection tube 11 is shown in FIGS. 8A to 8D. As with the implementations described above, liquid is extracted by generating a pressure difference between the volume of gas 21 within the blood collection tube 11 and the liquid extraction outlet 708 when the piston 704 is moved from the first configuration (FIG. 8B) to the second configuration (FIG. 8D). In the implementation shown in FIGS. 8B to 8D, the pressure difference is generated during actuation of the piston 704 from the first configuration to the second configuration.

The blood collection tube 11 is attached to the liquid extraction device 700 in the same manner as in the above implementations. Once attached, there is no pressure difference between the volume of gas 21 and the liquid extraction outlet 708.

Application of a downward force on the blood collection tube 11 displaces the piston 704 downwardly within the cylinder 702 and past the outlet 716. Further downward movement reduces the volume of the chamber 720, thereby increasing the pressure of the air within the chamber 720. This forces air through the needle 706 and into the blood collection tube 11, which increases the pressure of the volume of gas 21 within the blood collection tube 11. The downward movement of the piston 704 also compresses the spring 734. At the end of the stroke (FIG. 8B), the piston 704 is in the first configuration and the pressure of air within the chamber 720 and within the blood collection tube 11 has been increased, but there is no difference in pressure.

Releasing the downward force applied to the blood collection tube 11 results in an upward force being applied to the piston 704 by the spring 734. The upward force applied by the spring 734 increases the volume of the chamber 720, thereby reducing the pressure of the air within the chamber 720. This results in a pressure difference between the liquid extraction outlet 708 and the volume of gas 21, which forces liquid through the needle 706 and into the chamber 720 (as shown in FIG. 8C). The spring 734 continues to apply an upward force to the piston 704 (thereby providing a pressure difference that results in extraction of liquid) until the piston 704 returns to the second configuration (its starting position), shown in FIG. 8D.

Once the blood collection tube 11 is disconnected from the liquid extraction device 700, the chamber 720 is vented via the needle 706. The extracted liquid can then be aspirated from the chamber 720 of the liquid extraction device 700 into a chamber of a cartridge via the outlet 716.

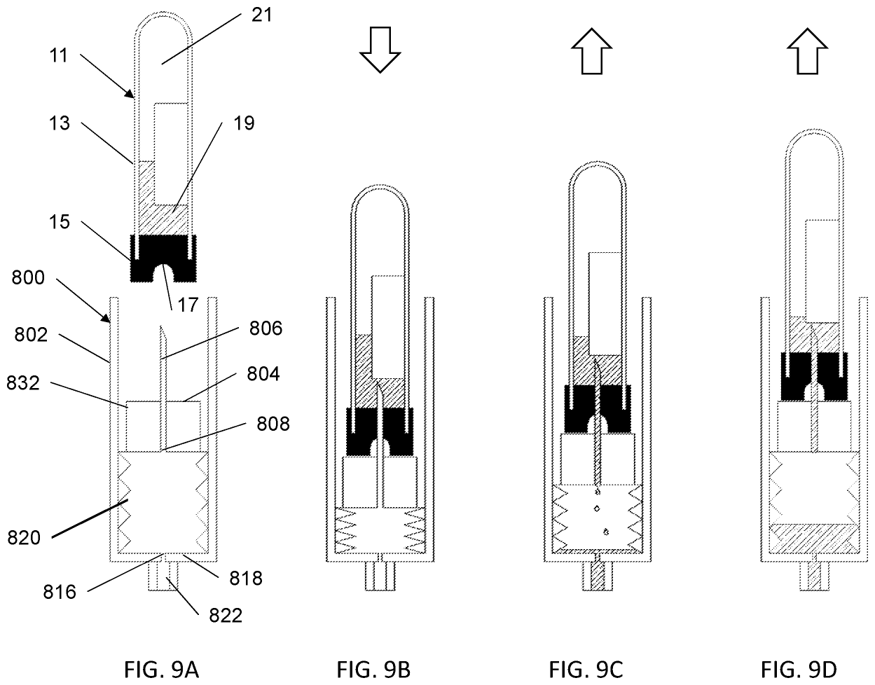

FIGS. 9A to 9D show a seventh liquid extraction device 800 being used to extract liquid from the blood collection tube 11. FIG. 9A shows the liquid extraction device 800 prior to attachment of the blood collection tube 11. The liquid extraction device 800 can be used to extract liquid from the blood collection tube 11 in the same manner as the liquid extraction device 700 shown in FIGS. 8A to 8D, but includes a resiliently deformable bellows chamber 820 as an alternative to the spring 734 used in the liquid extraction device 700.

The liquid extraction device 800 comprises an actuatable liquid extraction mechanism in the form of a piston 804 moveable within a cylinder 802 from a first configuration (FIG. 9B) to a second configuration (FIG. 9D). As with the liquid extraction device 600 shown in FIGS. 7A to 7D, the piston 804 comprises a support 832 and an unvented compressible bellows chamber 820 disposed between the support 832 and an end wall 818 of the cylinder 802. The bellows chamber 820 has concertinaed sides that allow the volume of the bellows chamber 820 to be reduced from a first volume shown in FIGS. 9A and 9D (i.e. when the piston 804 is in the second configuration) to a reduced volume shown in FIG. 9B (i.e. when the piston 804 is in the first configuration).

The liquid extraction device 800 also includes a liquid storage container interface (e.g. a blood collection tube interface) in the form of a needle 806 having a liquid extraction outlet 808. The liquid extraction outlet 808 is in fluidic communication with the bellows chamber 820.

The cylinder 802 includes an outlet 816 that allows liquid extracted from the blood collection tube 11 to be removed from the liquid extraction device 800. The outlet 816 is in fluidic communication with a connector 822 that provides for attachment of the liquid extraction device 800 to a cartridge. The connector 822 is closed (unvented) during extraction of liquid from the blood collection tube 11, and is only opened when the liquid extraction device 800 is attached to a cartridge.

The procedure for extracting liquid from the blood collection tube 11 is shown in FIGS. 9A to 9D. As with the implementations described above, liquid is extracted by generating a pressure difference between the volume of gas 21 within the blood collection tube 11 and the liquid extraction outlet 808 when the piston 804 is moved from the first configuration (FIG. 9B) to the second configuration (FIG. 9D). In the implementation shown in FIGS. 9B to 9D, the pressure difference is generated during actuation of the piston 804 from the first configuration to the second configuration.

The procedure for extracting liquid is the same as for the liquid extraction device 700 shown in FIGS. 8A to 8D. In summary, the blood collection tube 11 is firstly attached. An applied downward force then reduces the volume of the bellows chamber 820 and thereby increases the air pressure within the bellows chamber 820 and within the blood collection tube 11 (FIG. 9B). Releasing the downward force then results in an upward force being applied to the piston 804 by the resiliently deformable bellows chamber 820 (FIG. 9C). This increases the volume of the bellows chamber 820 and reduces the air pressure within the bellows chamber 820, thereby generating a pressure difference that draws liquid out of the blood collection tube 11 via the needle, until the piston 804 is returned to the second configuration (FIG. 9D).

Once the blood collection tube 11 is disconnected from the liquid extraction device 800, the bellows chamber 820 is vented via the needle 806. The extracted liquid can then be aspirated from the chamber 820 of the liquid extraction device 800 into a chamber of a cartridge via the outlet 816.

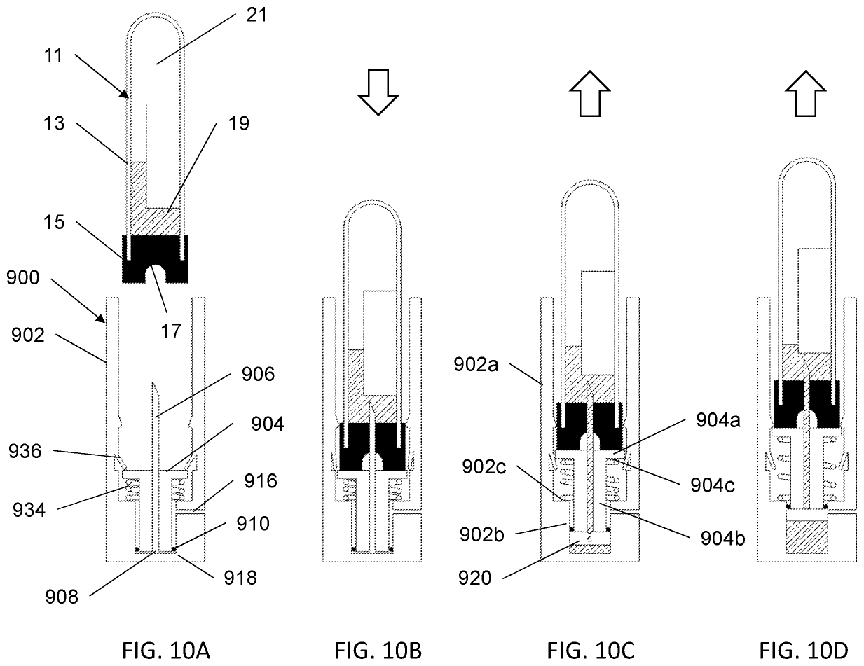

FIGS. 10A to 10D show an eighth liquid extraction device 900 being used to extract liquid from the blood collection tube 11. FIG. 10A shows the liquid extraction device 900 prior to attachment of the blood collection tube 11. The liquid extraction device 900 is used to extract liquid from the blood collection tube 11 using a resiliently deformable element to generate a negative pressure within a chamber 920 (as with the liquid extraction devices 700, 800 shown in FIGS. 8A to 8D and 9A to 9D). In contrast to the liquid extraction devices 700, 800, however, the liquid extraction device 900 includes a mechanism that releases the resiliently deformable element from a compressed state, in order to apply an upward force to a piston 904. This avoids the need for a downward force to be applied by the user to compress the resiliently deformable element.

The liquid extraction device 900 comprises an actuatable liquid extraction mechanism in the form of a piston 904 moveable within a cylinder 902 from a first configuration (FIG. 10B) to a second configuration (FIG. 10D). The liquid extraction device 900 also includes a liquid storage container interface (e.g. a blood collection tube interface) in the form of a needle 906 having a liquid extraction outlet 908.

In the example shown in FIGS. 10A to 10D, the cylinder 902 comprises a first cylindrical portion 902a having a first cross-section and a second cylindrical portion 902b having a second cross-section smaller than the first cross-section. An annular wall 902c joins the first cylindrical portion 902a to the second cylindrical portion 902b.

Likewise, the piston 904 comprises a first cylindrical piston portion 904a having a first cross-section, a second cylindrical piston portion 904b having a second cross-section smaller than the first cross-section, and an annular surface 904c joining the first cylindrical piston portion 904a to the second cylindrical piston portion 904b. The cross-section of the first cylindrical piston portion 904a is in between the cross-section of the first cylindrical portion 902a and the second cylindrical portion 902b. The cross-section of the second cylindrical piston portion 904b is smaller than the cross-section of the second cylindrical portion 902b such that the second cylindrical piston portion 904b is moveable within the second cylindrical portion 902b. The liquid extraction outlet 908 is provided at the base of the second cylindrical piston portion 904b.

The liquid extraction device 900 also comprises a resiliently deformable element in the form of a spring 934. The spring 934 is attached to the annular wall 902c of the cylinder 902 and the annular surface 904c of the piston 904. When compressed, the spring 934 biases the annular surface 904c of the piston 904 away from the annular wall 902c of the cylinder 902.

The piston 904 further comprises a sealing element in the form of an O-ring seal 910 extending around the circumference of the piston 904 at the base of the piston 904. Specifically, the O-ring seal 910 extends around the circumference of the second cylindrical piston portion 904b at the base of the second cylindrical piston portion 904b.

The cylinder 902 also includes an outlet 916 that allows liquid extracted from the blood collection tube 11 to be removed from the liquid extraction device 900. The outlet 916 is provided in a side wall of the cylinder 902. Specifically, the outlet 916 is provided in a side wall of the second cylindrical portion 902b.

Together, the piston 904 (specifically, the second cylindrical piston portion 904b) and the cylinder 902 (specifically, the second cylindrical portion 902b) define a chamber 920. In particular, the chamber 920 is defined between the second cylindrical piston portion 904b and an end wall 918 at the end of the second cylindrical portion 902b. The chamber 920 is vented once the O-ring seal 910 is actuated beyond the outlet 916 by the application of the upwards force from the spring 934 on the annular surface 902c.

The cylinder 902 further includes resiliently deformable clips 936 that extend inwardly from an internal wall of the first cylinder portion 902a. The clips 936 hinge from the internal wall of the first cylinder portion 902a. The clips 936 extend sufficiently far from the internal wall so as to hold the piston 904 in the position shown in FIG. 10A. In this position, the spring 934 is compressed and the piston 904 is held in place by the resiliently deformable clips 936. In particular, the spring 934 applies an upward force that forces the first cylindrical piston portion 904a against the clips 936.

The resiliently deformable clips 936 are dimensioned such that they are capable of being pushed towards the internal wall of the first cylinder portion 902a by the rim of the cap 15 of the blood collection tube 11. Once the clips 936 are displaced towards the internal wall of the first cylinder portion 902a by the cap 15, the piston 904 is unclipped and is free to move upwardly within the cylinder 902 (by the upward force applied by the spring 934).

The procedure for extracting liquid from the blood collection tube 11 is shown in FIGS. 10A to 10D. As with the implementations described above, liquid is extracted by generating a pressure difference between the volume of gas 21 within the blood collection tube 11 and the liquid extraction outlet 908 when the piston 904 is moved from the first configuration (FIG. 10B) to the second configuration (FIG. 10D). In the implementation shown in FIGS. 10B to 10D, the pressure difference is generated during actuation of the piston 904 from the first configuration to the second configuration.

Initially, the piston 904 is held in place in the first configuration by the resiliently deformable clips 936. The blood collection tube 11 is attached to the liquid extraction device 900 by applying a downward force to the blood collection tube 11 so that the needle 906 pierces the septum 17. Once the needle 906 is fully inserted through the septum 17, the cap 15 forces the clips 936 outwardly towards the interior walls of the cylinder 902. This unclips and releases the piston 904, as shown in FIG. 10B. At this point, there is no difference in pressure between the liquid extraction outlet 908 and the volume of gas 21.

The release of the piston 904 from the clips 936 results in an upward force being applied to the piston 904 by the spring 934. The upward force applied by the spring 934 increases the volume of the chamber 920, thereby reducing the pressure of air within the chamber 920. This results in a pressure difference between the liquid extraction outlet 908 and the volume of gas 21, which forces liquid through the needle 906 and into the chamber 920 (FIG. 10C). The spring 934 continues to apply an upward force to the piston 904 (thereby providing a pressure difference that results in extraction of liquid) until the piston 904 reaches the second configuration (FIG. 10D).

Once the blood collection tube 11 is disconnected from the liquid extraction device 900, the chamber 920 is vented via the needle 906. The extracted liquid can then be aspirated from the chamber 920 of the liquid extraction device 900 into a chamber of a cartridge via the outlet 916.

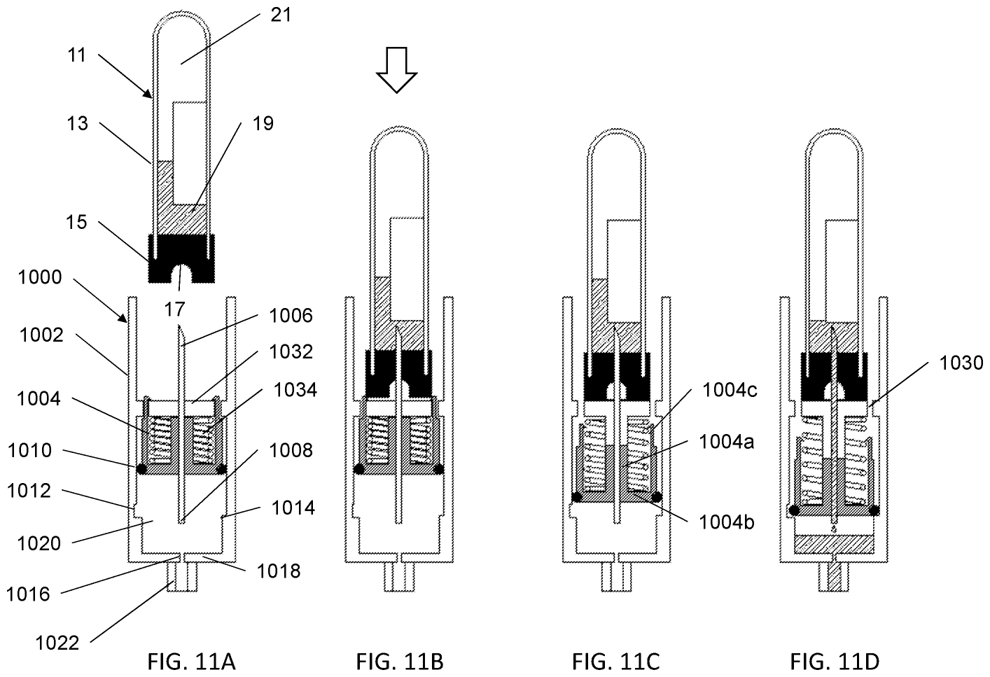

FIGS. 11A to 11D show a ninth liquid extraction device 1000 being used to extract liquid from the blood collection tube 11. FIG. 11A shows the liquid extraction device 1000 prior to attachment of the blood collection tube 11. The liquid extraction device 1000 extracts liquid in a similar manner to the liquid extraction device 300 shown in FIGS. 3A to 3D, but uses a piston 1004 that is actuated from a first configuration to a second configuration using a resiliently deformable element, rather than by application of a force by a user.

As with the liquid extraction device 300 shown in FIGS. 3A to 3D, the liquid extraction device 1000 shown in FIGS. 11A to 11D comprises an actuatable liquid extraction mechanism in the form of a piston 1004 moveable within a cylinder 1002 from a first configuration to a second configuration. The liquid extraction device 1000 also includes a liquid storage container interface (e.g. a blood collection tube interface) in the form of a needle 1006 having a liquid extraction outlet 1008.

The piston 1004 includes a sealing element in the form of an O-ring seal 1010 extending around the circumference of the piston 1004 at the base of the piston 1004. The cylinder 1002 includes an aperture in the form of a recess 1012 that extends around at least part of the circumference of the internal side wall of the cylinder 1002. The recess 1012 provides a path for air to flow around the O-ring seal 1010, thereby compromising the O-ring seal 1010, when the piston 1004 is in the second configuration.

The cylinder 1002 also includes a stop 1014 that protrudes from the internal side wall of the cylinder 1002 and extends around at least part of the circumference of the internal wall to prevent downward movement of the piston 1004 within the cylinder 1002 beyond the point at which the stop 1014 protrudes. The stop 1014 is provided to align the O-ring seal 1010 of the piston 1004 with the recess 1012 in the cylinder 1002 when the piston 1004 abuts the stop 1014.

The cylinder 1002 also includes an outlet 1016 that allows liquid extracted from the blood collection tube 11 to be removed from the liquid extraction device 1000. The outlet 1016 is provided in an end wall 1018 of the cylinder 1002 and is in fluidic communication with a connector 1022 that allows the liquid extraction device 1000 to be attached to a cartridge. The connector 1022 seals the chamber 1020 until the liquid extraction device 1000 is attached to a cartridge.

Together, the piston 1004 and the cylinder 1002 define an unvented chamber 1020. Specifically, the chamber 1020 is defined between the end wall 1018 of the cylinder 1002 and the piston 1004. The liquid extraction outlet 1008 is in fluidic communication with the chamber 1020.

In contrast to the liquid extraction device 300 shown in FIGS. 3A to 3D, the liquid extraction device 1000 further comprises a support 1032 located within the cylinder 1002. The support 1032 extends across at least part of the cross-section of the cylinder 1002 and may, for example, extend from the interior side walls of the cylinder 1002. The needle 1006 is fixedly mounted within the support 1020 and extends through the support 1020.

The piston 1004 is disposed beneath the support 1020. The piston 1004 comprises a central cylindrical portion 1004a comprising a central hole through which the needle 1006 is disposed. The central hole in the central cylindrical portion 1004a allows the piston 1004 to be slidably moveable with respect to the needle 1006. The central cylindrical portion 1004a is joined to an end portion 1004b to which the O-ring seal 1010 is attached. The central hole also extends through the end portion 1004b of the piston 1004. The piston 1004 also comprises resiliently deformable clips 1004c that extend upwardly from the end portion 1004. The clips 1004c are received in corresponding apertures 1030 in the support 1020. The clips 1004c retain the piston 1004 in the first configuration (FIG. 11B) until they are disengaged from the apertures 1030. The clips 1004c and apertures 1030 are dimensioned such that the clips 1004c can be deformed out of engagement with the apertures 1030 by abutment of the cap 15 of the blood collection tube 11 against the clips 1004c.

The liquid extraction device further comprises a spring 1034 disposed between the end portion 1004b of the piston 1004 and a lower surface of the support 1020. When compressed, the spring 1034 biases the end portion 1004b of the piston 1004 away from the support 1020.

The procedure for extracting liquid from the blood collection tube 11 is shown in FIGS. 11A to 11D. As with the implementations described above, liquid is extracted by generating a pressure difference between the volume of gas 21 within the blood collection tube 11 and the liquid extraction outlet 1008 when the piston 1004 is moved from the first configuration (FIG. 11B) to the second configuration (FIG. 11D). In the implementation shown in FIGS. 11B to 11D, the pressure difference is generated once the piston 1004 is in the second configuration.

Initially, the piston 1004 is held in place in the first configuration by the resiliently deformable clips 1004c. The blood collection tube 11 is attached to the liquid extraction device 1000 by applying a downward force to the blood collection tube 11 so that the needle 1006 pierces the septum 17. Once the needle 1006 is fully inserted through the septum 17, the cap 15 forces the clips 1004c outwards, so that they are pushed out of engagement with the apertures 1030 in the support 1020. This unclips and releases the piston 1004. Initially, there is no difference in pressure between the liquid extraction outlet 1008 and the volume of gas 21.

The release of the piston 1004 from the clips 1004c results in a downward force being applied to the piston 1004 by the spring 1034. The downward force applied by the spring 1034 pushes the piston 1004 downwards (away from the support 1020), and reduces the volume of the chamber 1020, thereby increasing the pressure of the air within the chamber 1020 (as shown in FIG. 11C). The increase in air pressure within the chamber 1020 forces air through the needle 1006 and therefore increases the air pressure within the blood collection tube 11. At this point, there is no pressure difference between the liquid extraction outlet 1008 (within the chamber 1020) and the volume of gas 21 within the blood collection tube 11.

Further downward movement of the piston 1004 by the spring 1034 results in a further increase in pressure of the volume of gas 21, until the piston 1004 reaches the second configuration (FIG. 11D). In the second configuration, the O-ring seal 1010 is aligned with the recess 1012. This allows air from the chamber 1020 to escape around the O-ring seal 1020 via the recess 1012. At this point, the chamber 1020 and the liquid extraction outlet 1008 are at atmospheric pressure, whereas the volume of gas 21 is above atmospheric pressure. This pressure difference forces liquid through the needle 1006 and into the chamber 1020 via the liquid extraction outlet 1008.

As the chamber 1020 is vented, the extracted liquid can be aspirated from the chamber 1020 into a chamber of a cartridge. The blood collection tube 11 can then be disconnected from the liquid extraction device 1000.

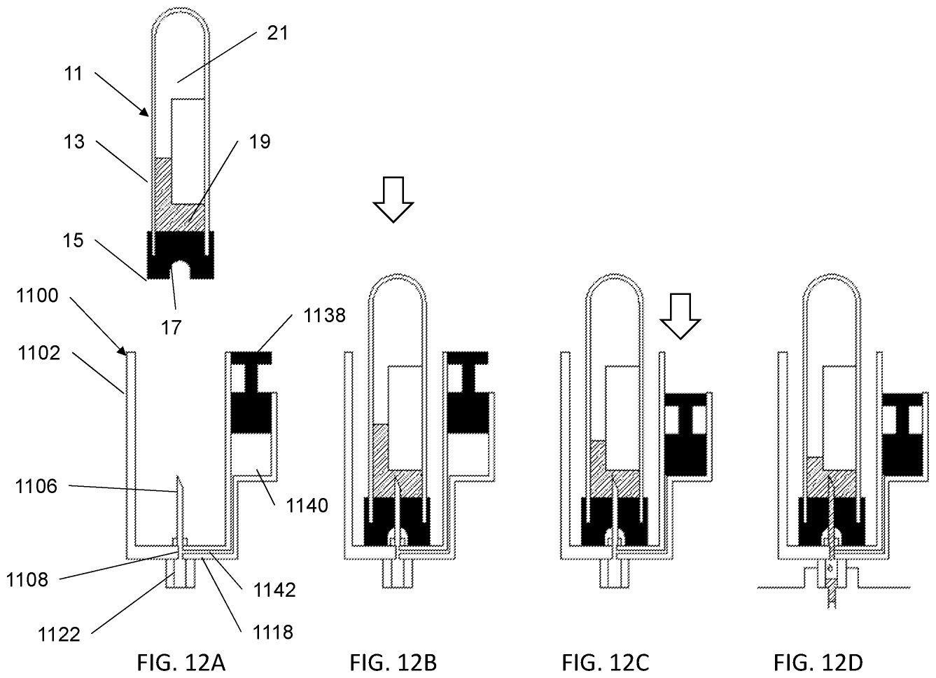

FIGS. 12A to 12D show a tenth liquid extraction device 1100 being used to extract liquid from the blood collection tube 11. FIG. 12A shows the liquid extraction device 1100 prior to attachment of the blood collection tube 11. The liquid extraction device 1100 uses a static attachment of the blood collection tube 11 to a needle 1106, with the actuatable liquid extraction mechanism being provided externally to a cylinder 1102. Specifically, the liquid extraction mechanism is provided in the form of a plunger 1138.

As with the implementations described above, the liquid extraction device 1100 comprises a cylinder 1102 in which a blood collection tube 11 is received. The liquid extraction device 1100 also comprises a liquid storage container interface (e.g. a blood collection tube interface) in the form of a needle 1106. The needle 1106 is fixedly attached to an end wall 1118 of the cylinder 1102. When the blood collection tube 11 is attached to the liquid extraction device 1100, the cap 15 abuts the end wall 1118.

The needle 1106 comprises a liquid extraction outlet 1108. In the example shown in FIGS. 12A to 12D, the liquid extraction outlet 1108 is the same as the outlet from the cylinder 1102. The liquid extraction device 1100 also comprises a connector 1122 that allows the liquid extraction device 1100 to be attached to a cartridge.

The liquid extraction device 1100 also comprises an actuatable liquid extraction mechanism in the form of a plunger 1138 that is moveable within a housing 1140 from a first configuration (FIGS. 12A and 12B) to a second configuration (FIGS. 12C and 12D). The interface between the plunger 1138 and the housing 1140 is sealed (e.g. using an O-ring or similar sealing element, not shown in FIGS. 12A to 12D), so that air does not flow out of the housing 1140 around the sides of the plunger 1138.

As shown in FIGS. 12A to 12D, the housing 1140 may be attached to a side wall of the cylinder 1102. The liquid extraction mechanism also comprises an air transfer conduit 1142 that is in fluidic communication with the housing 1140 and the liquid extraction outlet 1108. When the plunger 1138 is actuated from the first configuration to the second configuration, air is forced out of the housing 1140 and through the air transfer conduit 1142 to the liquid extraction outlet 1108.

The procedure for extracting liquid from the blood collection tube 11 is shown in FIGS. 12A to 12D. Liquid is extracted by generating a pressure difference between the volume of gas 21 within the blood collection tube 11 and the liquid extraction outlet 1108 when the plunger 1138 is moved from the first configuration (FIG. 12B) to the second configuration (FIG. 12D). In the implementation shown in FIGS. 12A to 12D, the pressure difference is generated once the plunger 1138 is in the second configuration.

The blood collection tube 11 is attached to the liquid extraction device 1100 by application of a downward force on the blood collection tube 11 so that the needle 1106 pierces the septum 17. The blood collection tube 11 is fully attached once the cap 15 abuts the end wall 1118 of the cylinder 1102.

Initially, the plunger 1138 is in the first configuration (FIG. 12B). The plunger 1138 is actuated to the second configuration by applying a downward force to the plunger 1138 to push the plunger 1138 into the housing 1140. Pushing the plunger 1138 into the housing 1140 displaces the air within the housing 1140 into the air transfer conduit 1142 (FIG. 12C). As the air transfer conduit 1142 is in fluidic communication with the liquid extraction outlet 1108, the air is forced into the blood collection tube 11 via the liquid extraction outlet 1108 and the needle 1106. This increases the pressure of air within the blood collection tube 11.

A pressure difference between the liquid extraction outlet 1108 and the volume of gas 21 is generated when the liquid extraction outlet 1108 is vented. The liquid extraction outlet 1108 may be vented in different ways. As a first example, the liquid extraction outlet 1108 may be connected to a cartridge that is vented after the plunger 1138 has been depressed. As a second example, the connector 1122 may include a valve that is opened after the plunger 1138 has been depressed. As a third example, the plunger 1138 may be depressed prior to attachment of the liquid extraction device 1100 to a cartridge, and the connector 1122 may include a seal that is pierced, ruptured or torn when the liquid extraction device 1100 is attached to a vented cartridge. The venting of the liquid extraction outlet 1108 means that the liquid extraction outlet 1108 is at atmospheric pressure, whereas the volume of gas 21 is above atmospheric pressure. This difference in pressure forces liquid out of the liquid extraction outlet 1108, via the needle 1106, thereby expelling the extracted liquid from the liquid extraction device 1100. The blood collection tube 11 can then be removed from the liquid extraction device 1100.

A modification to the tenth liquid extraction device 1100 includes two needles. A first needle is in fluidic communication with the air transfer conduit 1142, and transfers air from the housing 1140 to the blood collection tube 11. A second needle provides a fluidic connection to the volume of liquid 19, and comprises the liquid extraction outlet 1108, which provides the outlet from the liquid extraction device and is at atmospheric pressure. In this modified device, liquid is again extracted by generating a pressure difference between the volume of gas 21 and the liquid extraction outlet 1108 when the plunger 1138 is moved from the first configuration to the second configuration. However, the pressure difference is generated during actuation of the plunger 1138 from the first configuration to the second configuration.

Specifically, actuation of the plunger 1138 transfers air from the housing 1140 into the blood collection tube 11 via the air transfer conduit 1142 and the first needle, which increases the pressure of the volume of gas 21 within the blood collection tube 11. As there is a pressure difference between the volume of gas 21 and the liquid extraction outlet 1108, liquid is forced out of the second needle (e.g. to a chamber of a connected vented cartridge).

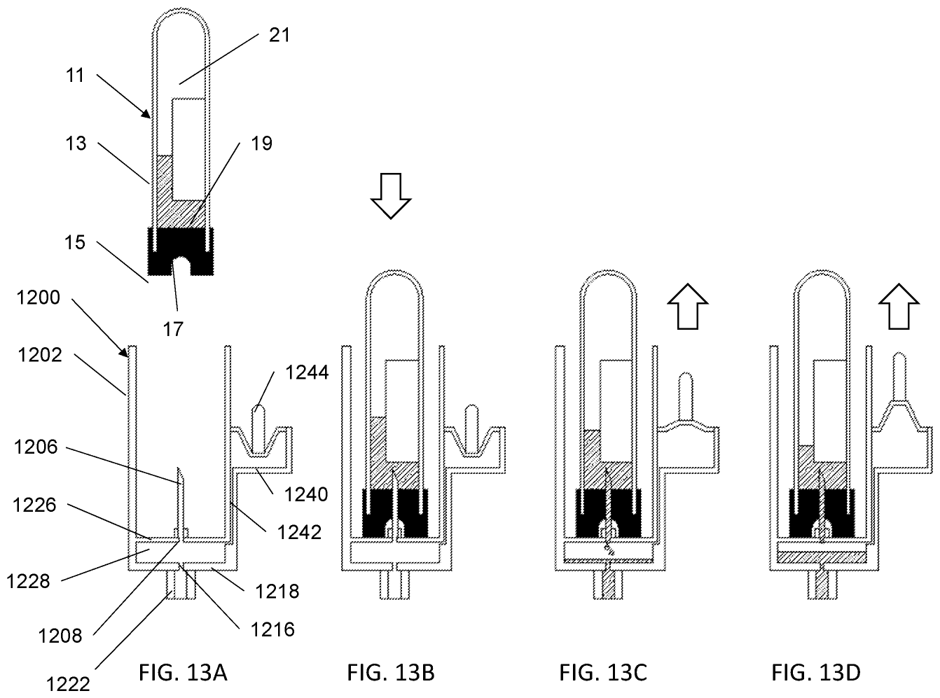

FIGS. 13A to 13D show an eleventh liquid extraction device 1200 being used to extract liquid from the blood collection tube 11. FIG. 13A shows the liquid extraction device 1200 prior to attachment of the blood collection tube 11. As with the liquid extraction device 1100 shown in FIGS. 12A to 12D, the liquid extraction device 1200 uses a static attachment of the blood collection tube 11 to a needle 1206, with the actuatable liquid extraction mechanism being provided externally to a cylinder 1202. Specifically, the liquid extraction mechanism is provided in the form of a pull-tab 1244 that generates a negative pressure.

The liquid extraction device 1200 comprises a cylinder 1202 in which a blood collection tube 11 is received. The liquid extraction device 1200 also comprises a liquid storage container interface (e.g. a blood collection tube interface) in the form of a needle 1206. The cylinder 1202 comprises a dividing wall 1226 that defines an unvented chamber 1228 within an end portion of the cylinder 1202 (specifically, between an end wall 1218 and the dividing wall 1226). The needle 1206 is fixedly attached to the dividing wall 1226. When the blood collection tube 11 is attached to the liquid extraction device 1200, the cap 15 abuts the dividing wall 1226.

The needle 1206 comprises a liquid extraction outlet 1208 that is in fluidic communication with the chamber 1228. The liquid extraction device 1200 also comprises an outlet 1216 from the chamber 1228, which is provided in the end wall 1218. The outlet 1216 allows liquid extracted from the blood collection tube 11 to be removed from the liquid extraction device 1200. In addition, the liquid extraction device 1200 comprises a connector 1222 in fluidic communication with the outlet 1216. The connector 1222 allows the liquid extraction device 1200 to be attached to a cartridge.

The liquid extraction device 1200 further comprises an actuatable liquid extraction mechanism in the form of a pull-tab 1244 joined to a housing 1240. The pull-tab 1244 is moveable from a first configuration (FIGS. 13A and 13B) to a second configuration (FIG. 13D). The interface between the pull-tab 1244 and the housing 1240 is sealed, so that air does not flow out of the housing 1240 around the sides of the pull-tab 1244.

As shown in FIGS. 13A to 13D, the housing 1240 may be attached to a side wall of the cylinder 1202. The liquid extraction mechanism also comprises an air transfer conduit 1242 that is in fluidic communication with the housing 1240 and the chamber 1228. When the pull-tab 1244 is actuated (i.e. pulled) from the first configuration to the second configuration, air is forced out of the chamber 1228 and into the housing 1240 through the air transfer conduit 1242.

The procedure for extracting liquid from the blood collection tube 11 is shown in FIGS. 13A to 13D. Liquid is extracted by generating a pressure difference between the volume of gas 21 within the blood collection tube 11 and the liquid extraction outlet 1208 when the pull-tab 1244 is moved from the first configuration (FIG. 13B) to the second configuration (FIG. 13D). In the implementation shown in FIGS. 13A to 13D, the pressure difference is generated during actuation of the pull-tab 1244 from the first configuration to the second configuration.

The blood collection tube 11 is attached to the liquid extraction device 1200 by application of a downward force on the blood collection tube 11 so that the needle 1206 pierces the septum 17. The blood collection tube 11 is fully attached once the cap 15 abuts the dividing wall 1226 of the cylinder 1202 (FIG. 13B).

Application of an upward force to the pull-tab 1244 increases the volume of the housing 1240 (FIG. 13C). The increase in volume of the housing 1240 draws air out of the chamber 1228 through the air transfer conduit 1242 and reduces the pressure of air within the chamber 1228. This means that there is a pressure difference between the volume of gas 21 within the blood collection tube 11 (which is at atmospheric pressure) and the liquid extraction outlet 1208 (which is below atmospheric pressure). This pressure difference forces liquid through the needle 1206 and into the chamber 1228 through the liquid extraction outlet 1208.

Further upward movement of the pull-tab 1244 maintains the negative pressure within the chamber 1228, thereby drawing more liquid out of the blood collection tube 11. This continues until the pull-tab 1244 reaches the second configuration, shown in FIG. 13D. In this position, the volume of the housing 1240 is at a maximum and liquid is drawn out of the blood collection tube 11 until the pressures of the volume of gas 21 and the liquid extraction outlet 1208 equalize.

Once the blood collection tube 11 is disconnected from the liquid extraction device 1200, the chamber 1228 is vented via the needle 1206. The extracted liquid can then be aspirated from the chamber 1228 into a chamber of a cartridge, via the outlet 1216.

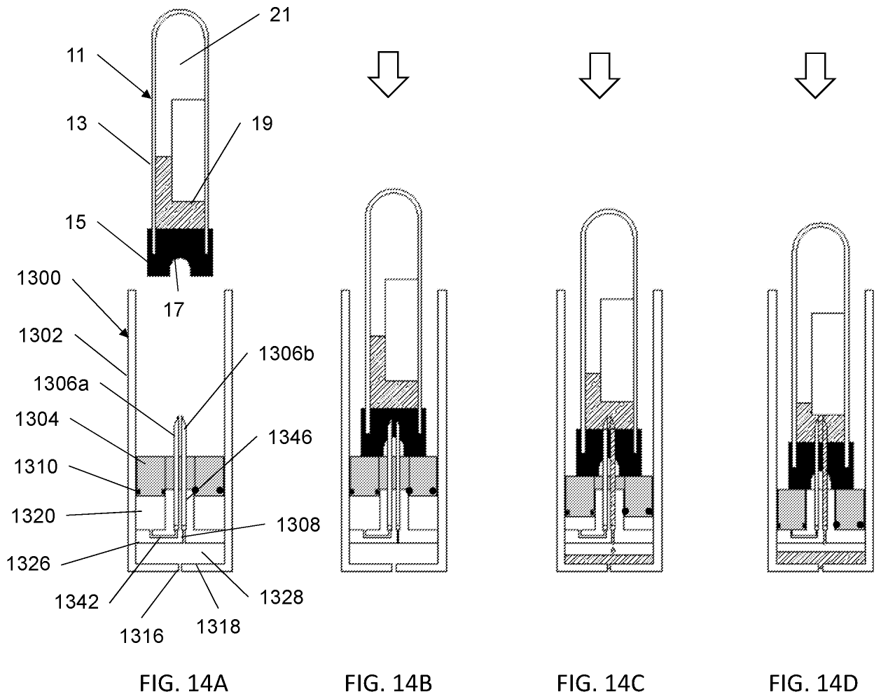

FIGS. 14A to 14D show a twelfth liquid extraction device 1300 being used to extract liquid from the blood collection tube 11. FIG. 14A shows the liquid extraction device 1300 prior to attachment of the blood collection tube 11. The liquid extraction device 1300 includes two needles 1306a, 1306b, which allows liquid to be extracted gradually using a positive pressure, during actuation of a piston 1304 from a first configuration to a second configuration.

The liquid extraction device 1300 includes a cylinder 1302 (or tube) in which the blood collection tube 11 is received. The liquid extraction device 1300 also includes an actuatable liquid extraction mechanism in the form of a piston 1304, and a liquid storage container interface (e.g. a blood collection tube interface) comprising a first needle 1306a and a second needle 1306b.

The cylinder 1302 comprises a dividing wall 1326 defining a chamber 1328 in an end portion of the cylinder 1302. Specifically, the chamber 1328 is defined between the dividing wall 1326 and an end wall 1318 of the cylinder 1302. The cylinder 1302 also comprises an outlet 1316 that provides a fluidic connection to the chamber 1328 and allows liquid extracted from the blood collection tube 11 to be removed from the liquid extraction device 1300.

A cylindrical support 1346 extends upwardly from the dividing wall 1326. The first and second needles 1306a, 1306b are held within the support 1346. The piston 1304 has an annular shape that supports the cap 15 of the blood collection tube 11 while passing around the support 1346. Two sealing elements in the form of inner and outer annular O-ring seals 1310 form a seal between the piston 1304 and the cylindrical support 1346, and between the piston 1304 and the cylinder 1302.

Together, the piston 1304, cylinder 1302 and cylindrical support 1346 define an unvented toroidal chamber 1320 between the piston 1304 and the dividing wall 1326. The liquid extraction device 1300 also includes an air transfer conduit 1342 within the dividing wall 1326, that provides a fluidic connection between the chamber 1320 and the first needle 1306a. The end of the second needle 1306b is in fluidic communication with the chamber 1328 in the end portion of the cylinder 1302 via a liquid extraction outlet 1308.

The procedure for extracting liquid from the blood collection tube 11 is shown in FIGS. 14A to 14D. As with the implementations described above, liquid is extracted by generating a pressure difference between the volume of gas 21 within the blood collection tube 11 and the liquid extraction outlet 1308 when the piston 1304 is moved from the first configuration to the second configuration. In the implementation shown in FIGS. 14A to 14D, the pressure difference is generated during actuation of the piston 1304 from the first configuration to the second configuration.

The blood collection tube 11 is attached to the liquid extraction device 1300 in the same manner as in the above implementations. Once attached, as shown in FIG. 14B (i.e. with the piston 1304 in the first configuration), there is no pressure difference between the volume of gas 21 and the liquid extraction outlet 1308.

Downward movement of the piston 1304 reduces the volume of the unvented chamber 1320, leading to an increase in the pressure of air within the chamber 1320. This forces air into the blood collection tube 11 via the air transfer conduit 1342 and the first needle 1306a, thereby increasing the pressure of the volume of gas 21.

At this point, there is a pressure difference between the volume of gas 21 within the blood collection tube 11, and the liquid extraction outlet 1308 (which is at the same pressure as the chamber 1328 in the end portion of the cylinder 1302). This pressure difference forces liquid out of the blood collection tube 11 and into the chamber 1328, via the second needle 1306b and the liquid extraction outlet 1308 (as shown in FIG. 14C). In particular, air flows into the blood collection tube 11 via the first needle 1306a, while liquid flows out of the blood collection tube 11 via the second needle 1306b.

Continued downward movement of the piston 1304 results in air being transferred from the chamber 1320 to the blood collection tube 11, maintaining the pressure difference between the air in the blood collection tube 11 and the air in the chamber 1328. This results in continued liquid flow into the chamber 1328, until the piston 1304 reaches the second configuration (FIG. 14D), where the piston 1304 abuts the dividing wall 1326. Liquid continues to flow into the chamber 1328 until the pressures of the volume of gas 21 and the liquid extraction outlet 1308 are equalised.

Once the blood collection tube 11 is disconnected from the liquid extraction device 1300, the chamber 1328 is vented via the second needle 1306b and the liquid extraction outlet 1308. The extracted liquid can then be aspirated from the chamber 1328 of the liquid extraction device 1300 into a chamber of the cartridge.

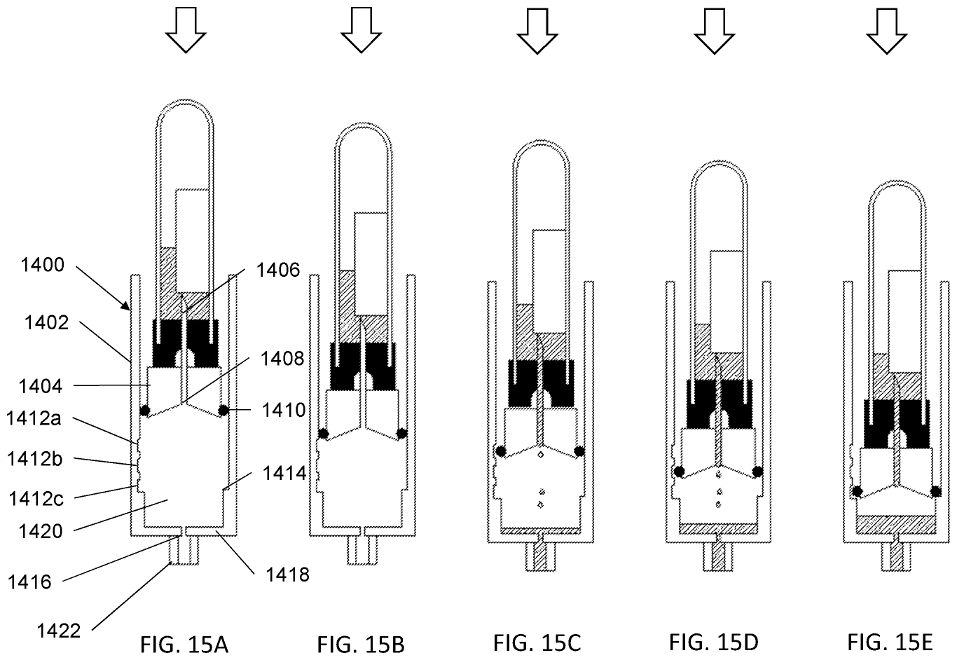

FIGS. 15A to 15E show a thirteenth liquid extraction device 1400 being used to extract liquid from the blood collection tube 11. The liquid extraction device 1400 can be used to extract liquid from the blood collection tube 11 in stages. This reduces the pressure difference that is generated between the volume of gas 21 within the blood collection tube 11 and a liquid extraction outlet 1408, which reduces the tendency for haemolysis to occur during extraction of liquid from the blood collection tube 11.

The liquid extraction device 1400 has essentially the same construction as the liquid extraction device 300 shown in FIGS. 3A to 3D, except that multiple apertures (specifically, a first recess 1412a, a second recess 1412b, and a third recess 1412c) are provided in an internal side wall of the cylinder 1402. The other features of the cylinder 1402 shown in FIGS. 15A to 15E (i.e. the stop 1414, outlet 1416, and end wall 1418) have the same functionality as the corresponding features of the cylinder 302 of the liquid extraction device 300 shown in FIGS. 3A to 3D. Likewise, the other features of the liquid extraction device 1400 shown in FIGS. 15A to 15E (i.e. the piston 1404, needle 1406, liquid extraction outlet 1408, O-ring seal 1410, and chamber 1420) have the same functionality as the corresponding features of the liquid extraction device 300 shown in FIGS. 3A to 3D.

Each recess 1412 of the liquid extraction device 1400 shown in FIGS. 15A to 15E extends around at least part of the circumference of the internal side wall of the cylinder 1402. Each recess 1412 provides a path for air to flow around the O-ring seal 1410 when the O-ring seal 1410 is aligned with that recess 1412. The stop 1414 is provided to align the O-ring seal with the third recess 1412c.

The procedure for extracting liquid from the blood collection tube 11 is shown in FIGS. 15A to 15E. As described in more detail below, a pressure difference between the volume of gas 21 within the blood collection tube 11 and the liquid extraction outlet 1408 is repeatedly generated when the piston 1404 is moved from the first configuration to the second configuration. Specifically, in the example shown in FIGS. 15A to 15E, pressure differences are generated (a) once the O-ring seal 1410 of the piston 1404 is aligned with the first recess 1412a, (b) once the O-ring seal 1410 of the piston 1404 is aligned with the second recess 1412b, and (c) once the piston is in the second configuration (in which the O-ring seal 1410 is aligned with the third recess 1412c).

The blood collection tube 11 is connected to the liquid extraction device 1400 in the same manner as for the liquid extraction device 300 shown in FIGS. 3A to 3D. At this point, there is no pressure difference between the volume of gas 21 and the liquid extraction outlet 1408.

Application of a downward force on the piston 1404 reduces the volume of the chamber 1420, which forces air into the blood collection tube 11 via the needle 1406. This increases the pressure of the volume of gas 21 within the blood collection tube 11. Further downward movement of the piston 1404 (to the position shown in FIG. 15B) results in a further increase in pressure of the air within the chamber 1420 and the blood collection tube 11, until the piston 1404 reaches a first intermediate position between the first and second configurations. In the first intermediate position, the O-ring seal 1410 of the piston 1404 is aligned with the first recess 1412a (FIG. 15C). When the piston 1404 is in this position, the O-ring seal 1410 is compromised, allowing air to escape around the O-ring seal 1410 via the first recess 1412a. This means that the higher pressure air within the chamber 1420 vents to the atmosphere. At this point, there is a pressure difference between the volume of gas 21 and the liquid extraction outlet 1408, meaning that liquid is forced out of the needle 1406 and into the chamber 1420 via the liquid extraction outlet 1408 (as shown in FIG. 15C).

Following the extraction of a portion of the liquid from the blood collection tube 11, further downward movement of the piston 1404 re-pressurises the chamber 1420 and the volume of gas 21 until the piston 1404 reaches a second intermediate position between the first and second configurations. In the second intermediate position, the O-ring seal 1410 is aligned with the second recess 1412b (FIG. 15D). This compromises the O-ring seal 1410, thereby depressurizing the chamber 1420 to provide a pressure difference between the volume of gas 21 and the liquid extraction outlet 1408. This pressure difference forces more liquid out of the needle 1406 and into the chamber 1420 via the liquid extraction outlet 1408 (as shown in FIG. 15D).

Finally, further downward movement of the piston 1404 beyond the second intermediate position again re-pressurises the chamber 1420 and the volume of gas 21 until the piston 1404 reaches the second configuration (FIG. 15E), in which the O-ring seal 1410 is aligned with the third recess 1412c. This compromises the O-ring seal 1410 to provide a pressure difference between the volume of gas 21 and the liquid extraction outlet 1408, which forces a final portion of the liquid out of the needle 1406 and into the chamber 1420 via the liquid extraction outlet 1408.

As the chamber 1420 is vented by the airflow through the third recess 1412b, the liquid extracted from the blood collection tube 11 can be aspirated from the chamber 1420 to a chamber of the cartridge. The blood collection tube 11 can also be removed from the liquid extraction device 1400.

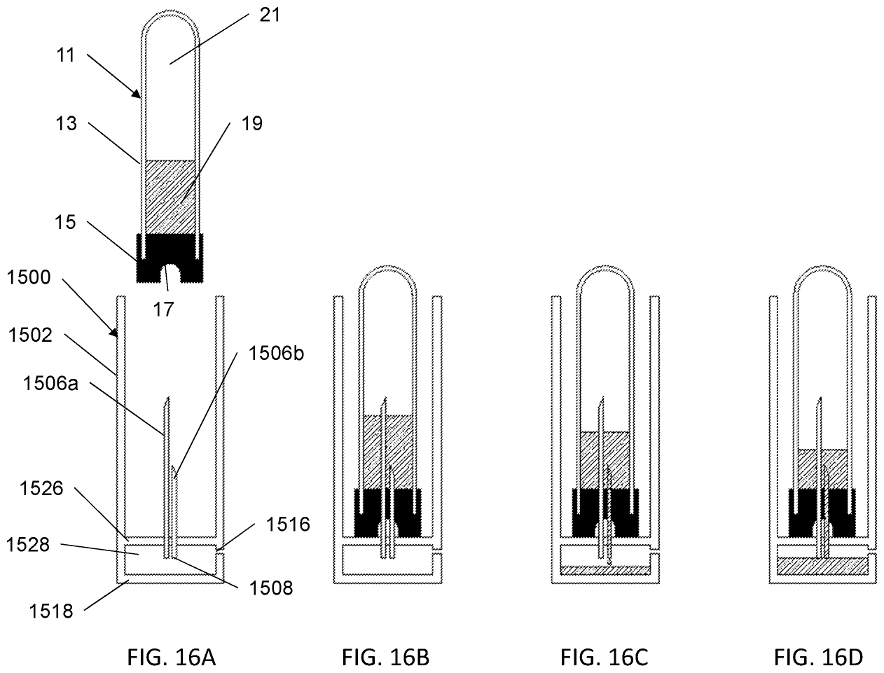

FIGS. 16A to 16D show a fourteenth liquid extraction device 1500 being used to extract liquid from the blood collection tube 11. The liquid extraction device 1500 extracts liquid from the blood collection tube 11 using a siphon-like effect.

The liquid extraction device comprises a cylinder 1502 having a dividing wall 1526 that defines a chamber 1528 in an end portion of the cylinder 1502 (between the dividing wall 1526 and an end wall 1518 of the cylinder 1502). An outlet 1516 is provided in a side wall of the cylinder 1502 and is in fluidic communication with the chamber 1528. The outlet 1516 allows liquid extracted from the blood collection tube 11 to be removed from the chamber 1528.

The dividing wall 1526 acts as a support for a liquid storage container interface (e.g. a blood collection tube interface) comprising a first needle 1506a and a second needle 1506b. Each needle 1506 protrudes upwardly from the dividing wall 1526 and has an end that extends partially into the chamber 1528.

The first needle 1506a is the longer of the two needles, and is configured to provide a fluidic connection to the volume of gas 21 within the blood collection tube 11. The second needle 1506b is shorter and is configured to provide a fluidic connection to the volume of liquid 19 within the blood collection tube 11. The end of the second needle 1506b that protrudes into the chamber 1528 is a liquid extraction outlet 1508.

Unlike the implementations described above, no actuation of a liquid extraction mechanism is required in order to extract liquid from the blood collection tube 11. The extraction of liquid from the blood collection tube 11 is described with reference to FIGS. 16A to 16D.

The blood collection tube 11 is attached to the liquid extraction device 1500 in the same manner as the above implementations, and is fully attached to the liquid extraction device 1500 when the cap 15 abuts the dividing wall 1526 (as shown in FIG. 16B). In this position, the first needle 1506a vents the volume of gas 21 within the blood collection tube 11 to the chamber 1528 so that the pressure difference between the volume of gas 21 and the chamber 1528 is constantly equalised. The liquid extraction outlet 1508 is at atmospheric pressure, but there is a pressure head of liquid above the upwardly protruding end of the second needle 1506b (i.e. above the tip of the second needle 1506b). This means that there is a pressure difference between the two ends of the second needle 1506b, which results in liquid being drawn into the chamber 1528 via the liquid extraction outlet 1508 (as shown in FIG. 16C). The extraction of liquid continues until (i) there is no pressure head of liquid above the tip of the second needle 1506b, or (ii) the level of liquid within the chamber 1528 reaches the end of the first needle 1506a, so that the volume of gas 21 is no longer vented (as shown in FIG. 15D).

The blood collection tube 11 can then be removed from the liquid extraction device 1500. Once removed, the chamber 1528 is vented through the needles 1506a, 1506b, which allows the extracted liquid to be aspirated from the chamber 1528 of the liquid extraction device 1500 to a chamber of a cartridge.

FIG. 18 shows a blood collection tube 11 being inserted into a cylinder of a liquid extraction device 400. In this example, the liquid extraction device 400 is integral with a cartridge 100 that comprises the functionality described above with reference to FIG. 1. The blood collection tube 11 is shown as being inserted into the cylinder when the cartridge 100 is in a vertical orientation. FIG. 18 also shows an optically clear window 130 in a side wall of the cartridge 100. The sample adequacy control chamber of the cartridge 100 is viewable through the window 130.

The configurations investigated for extracting liquid from the pierceable liquid storage container will now be described.

The needle sizes investigated for providing the fluidic connection to a pierceable liquid storage container (e.g. a blood collection tube) were sizes 16G to 26G, having typical lengths of between 13 mm and 40 mm. The pressures generated when investigating the process parameters were in the region of 100 mbar to 800 mbar, depending on the fill volume of the blood collection tube and the amount of air forced into the blood collection tube.

The main failure mode of concern is haemolysis, which is typically in the range of 0 to 100 mg/dl. Generally, more haemolysis occurs at: (i) higher pressures (either where more air is displaced into the liquid storage container, or where the fill level of the liquid storage container is higher); (ii) higher shear stress (either from longer needle lengths, or sharper needle inlets (angled rather than flat)); and (iii) higher flow rates (when using a large size needle lysis may occur at the needle exit).

High haematocrit levels slow down liquid flow and can even block narrow bore needles. This means that shorter length needles are better for high haematocrit samples, as the flow is faster (because the hydraulic resistance is lower, owing to the shorter length). The suitability of shorter needle lengths for high haematocrit samples needs to be balanced with the potential for haemolysis and the potential for needle blocking to occur. Shorter needles are not necessarily better for low haematocrit flows and are more likely to induce lysis at high flow rates. A similar trade-off exists for larger bore needles, which give higher flow rates and consequently faster delivery times, but carry a risk of higher lysis at the needle exit. This trade-off can be mitigated by making the exit from the needle as smooth as possible, so that the tendency for the higher flow rates to induce lysis at needle exit is minimised.

Lower pressures (e.g. 100 mbar to 300 mbar, equivalent to introducing 0.5 ml air into a 1.5 ml headspace) give a much wider window of process parameters for needle dimensions and shape, in terms of haemolysis sensitivity. This is because haemolysis is rarely observed at these pressures. A drawback is slower delivery times. Typical blood volumes delivered are around 350 μl, using 500 μl of air, so as long as sub-millilitre volumes can be tolerated at delivery times of around 10 seconds, then implementing this pressure range is the most robust approach to countering lysis sensitivity.

The effect of a small needle bore at low operating pressure is the potential for blocking the bore at high haematocrit levels. The effect of a larger needle bore is the high insertion force required to pierce the septum, along with the risk of de-capping a blood collection tube when removing the needle. In general, the needle size range 20G-21G has been found to provide a good balance between these considerations.

The needle length is an effective way of modulating flow rate, by changing the hydraulic resistance. The considerations affecting the needle length include: (i) the trade-off between the required flow rate, percentage haematocrit range, and risk of haemolysis; and (ii) that the tip of the needle must always be below the surface of the blood at the lowest potential fill volume, thereby affecting the overall length of the device.

In terms of needle entry shape, hypodermic openings constrict blood flow at the diamond-shaped opening, resulting in high shear forces and increased lysis. Changing the profile of the needle opening aids flow, without localised areas of high pressure.

Testing results have identified consistently good performance from testing pressures up to 300 mbar, using a 20-21G needles of 13-35 mm length. Preferably, the needles are 21G needles of 35 mm length, preferably including a 30 degree tip, and further preferably including anti-coring finishing. At least 300 μl of blood was extracted from a Vacutainer (RTM) blood collection tube over a blood haematocrit range of 20% to 65%, with extraction times varying from 2 seconds to 20 seconds.

Variations or modifications to the systems and methods described herein are set out in the following paragraphs.

The blood extraction devices described above may include porous media such as membranes, meshes or textiles to achieve additional functionality. The porous media may incorporate reagents or specific surface chemistries to deplete unwanted substances from the sample or promote reactions with specific substances to aid with further processing or analytical determinations. For example, the porous media may be provided to induce cell lysis in order to expose cellular content.

As one specific example, a plasma separation membrane to filter the blood as it is extracted from the blood collection tube 11. Specifically, the plasma separation membrane may filter the blood so that blood plasma is extracted by the liquid extraction device. The blood plasma can then be aspirated into the cartridge.

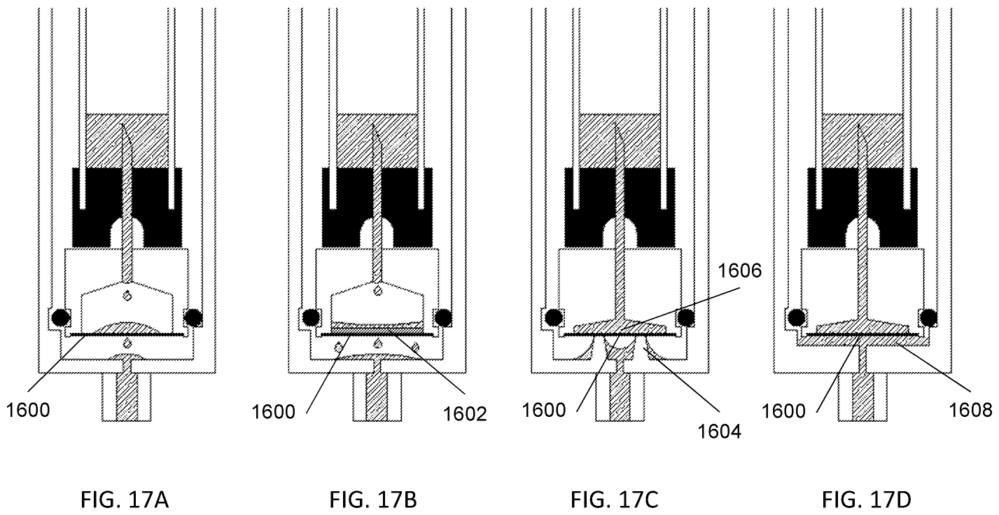

A plasma separation membrane 1600 is shown in FIG. 17A crimped to the base of the piston. The pressure difference generated by actuation of the liquid extraction mechanism draws liquid through the plasma separation membrane 1600, thereby filtering plasma from the blood.

As shown in FIG. 17B, a hydrophilic mesh 1602 may be disposed over the plasma separation membrane 1600 (i.e. so that the extracted liquid passes through the hydrophilic mesh 1602 prior to passing through the plasma separation membrane 1600). This improves wetting of the membrane 1600, which ensures that the full area of the membrane is contacted by the blood, and thereby improves liquid flow through the membrane 1600. The hydrophilic mesh 1602 also enables the device to be handled (e.g. rotated in a different orientation) without impacting the plasma extraction process. Similarly, membranes and/or meshes may be disposed on both sides of the plasma separation membrane 1600 to assist with extraction and provide a driving force for further fluid flow, for example similar to lateral flow technologies.

As shown in FIG. 17C, the cylinder may include protrusions 1604 that extend upwardly from the end wall of the cylinder, and that are arranged to contact the plasma separation membrane 1600 when the piston is in the second configuration. These features encourage liquid transport from the bottom of the plasma separation membrane 1600. The surface of the protrusions 1604 and adjacent areas may be provided with materials or coatings exhibiting wetting properties, for passive extraction of plasma.

A smaller volume of chamber 1606 above the plasma separation membrane may also be implemented. The use of a smaller volume of chamber 1606 improves membrane wettability and ensures that the full area of the membrane is contacted by the blood (similar to the hydrophilic mesh shown in FIG. 17B).

Finally, as shown in FIG. 17D, a small distance between the plasma separation membrane 1600 and the end wall of the cylinder may be implemented, resulting in a shallow chamber 1608 (e.g. less than 100 μm in height). Again, this encourages liquid transport from the bottom surface of the plasma separation membrane 1600.

As noted above, other porous media may be used in place of the plasma separation membrane shown in FIGS. 17A to 17D, in order to provide additional functionality.

In implementations where air is vented out of the outlet from the liquid extraction device (i.e. the outlet in the cylinder), to provide a sudden difference in pressure between the volume of gas within the blood collection tube and the liquid extraction outlet, an air filter may be implemented downstream of the outlet from the liquid extraction device. The air filter slows the release of air from the outlet from the liquid extraction device, meaning that the difference in pressure is generated more gradually, rather than a sudden step change. Controlling the pressure difference in this way reduces the tendency for haemolysis to occur in the extracted blood. In contrast, a sudden step change in pressure may result in aggressive extraction of blood, increasing the likelihood of haemolysis.

Although the above implementations are described with reference to extracting liquid from a blood collection tube such as a Vacutainer (RTM), it will be appreciated that the implementations described above are also suitable for extracting liquid from other forms of pierceable liquid storage containers, which may differ in size and/or shape from blood collection tubes. In such cases, the dimensions of the cylinder and piston may be adapted to the size and shape of the liquid storage container from which liquid is to be extracted. For example, although the above implementations are described with reference to a cylindrical tube in which the blood collection tube 11 is received, it will be appreciated that other cross-sections of tubes and pistons may be implemented to allow for extraction of liquid from other liquid storage containers.

Additionally, although the above implementations use a liquid storage container interface (e.g. a blood collection tube interface) in the form of one or more needles, other blood collection tube interfaces may be implemented, provided that they are capable of providing a fluidic connection to a volume of liquid within a liquid storage container (e.g. to the volume of liquid 19 within the blood collection tube 11).

The term “needle” in the above implementations is not intended to be limited to metal needles, and is intended to cover other piercing elements that are configured to pierce a septum of a blood collection tube, such as piercing elements that are integral with a piston. The needles described herein may have different configurations. For example, the needle or needles used in the above implementations may have angled or blunt tips, may include anti-coring features, and may be formed of various materials, such as stainless steel tubing or injection moulded plastic.

Although certain implementations are described above using resiliently deformable elements such as springs and bellows chambers, it will be appreciated that other resiliently deformable elements (e.g. O-rings) may be implemented in order to provide the functionality of the elements used in these implementations.

Although certain implementations use one or more sealing elements attached to a piston, the sealing elements may alternatively be attached to an interior wall of the cylinder. In implementations that use a recess that aligns with a sealing element, the recess may alternatively be provided on a surface of the piston. Although the above implementations describe sealing elements in the form of O-ring seals, the sealing elements may alternatively be provided in the form of a moulded plastic seal, or an over-moulded rubber seal.

Finally, although the above implementations are described with reference to a force applied by a user to actuate the liquid extraction mechanism, it will be appreciated that the liquid extraction mechanism may alternatively be actuated without requiring user input (e.g. under control of a motor).

As a general point, although the above implementations are described with reference to extracting liquid for use in a diagnostic test carried out using a cartridge, it will be appreciated that the liquid extraction devices described above are suitable for extracting liquid from a liquid storage container (e.g. a blood collection tube) for a wide range of other purposes.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

1. A liquid extraction device for extracting liquid from a pierceable liquid storage container, the liquid extraction device comprising:
a liquid storage container interface configured to provide a fluidic connection to a volume of liquid within the liquid storage container, the liquid storage container interface comprising a liquid extraction outlet configured to allow liquid to be extracted from the liquid storage container; and
a liquid extraction mechanism actuatable from a first configuration to a second configuration;
wherein the liquid extraction mechanism is configured to provide a pressure difference between a volume of gas in the liquid storage container and the liquid extraction outlet, when the liquid extraction mechanism is actuated from the first configuration to the second configuration.

2. A liquid extraction device according to claim 1, wherein the liquid storage container interface is configured to permit removal of the liquid storage container from the liquid storage container interface after extraction of liquid from the liquid storage container.

3. A liquid extraction device according to claim 1 or claim 2, wherein the liquid storage container interface comprises at least one needle configured to provide the fluidic connection to the volume of liquid within the liquid storage container.

4. A liquid extraction device according to any of claims 1 to 3, wherein the liquid extraction mechanism comprises a piston moveable within a receptacle, wherein the piston is actuatable from the first configuration to the second configuration.

5. A liquid extraction device according to claim 4, wherein the liquid storage container interface is attached to the piston.

6. A liquid extraction device according to claim 4 or claim 5, wherein the liquid extraction outlet is in fluidic communication with a chamber defined by the piston and the receptacle, wherein the chamber is in fluidic communication with the liquid extraction outlet.

7. A liquid extraction device according to claim 6, wherein the piston is configured to increase the pressure of air within the chamber when the piston is actuated from the first configuration to the second configuration.

8. A liquid extraction device according to any of claims 4 to 7, further comprising a sealing element configured to provide a seal between the piston and the receptacle when the piston is in the first configuration.

9. A liquid extraction device according to any of claims 1 to 8, wherein the liquid extraction mechanism is configured to provide the pressure difference between the volume of gas in the liquid storage container and the liquid extraction outlet once the liquid extraction mechanism is in the second configuration.

10. A liquid extraction device according to claim 9 when dependent on claim 8, further comprising a seal compromising element configured to compromise the sealing element once the piston is in the second configuration.

11. A liquid extraction device according to claim 10, wherein the seal compromising element comprises an aperture configured to compromise the sealing element when the piston is in the second configuration, such that air within the chamber is released via the aperture.

12. A liquid extraction device according to claim 11, further comprising an air filter configured to control the flow of air released via the aperture.

13. A liquid extraction device according to any of claims 10 to 12, wherein the seal compromising element is a first seal compromising element, and wherein the liquid extraction device further comprises a second seal compromising element configured to compromise the sealing element when the piston is actuated to a position in between the first configuration and the second configuration.

14. A liquid extraction device according to any of claims 1 to 8, wherein the liquid extraction mechanism is configured to provide the pressure difference between the volume of gas in the liquid storage container and the liquid extraction outlet during actuation of the liquid extraction mechanism from the first configuration to the second configuration.

15. A liquid extraction device according to claim 14 when dependent on claim 6, wherein the piston is configured to reduce the pressure within the chamber below the pressure of the volume of gas within the liquid storage container, when the piston is actuated from the first configuration to the second configuration.

16. A liquid extraction device according to claim 14, wherein the liquid storage container interface comprises at least two needles;
wherein a first one of the at least two needles is configured to provide the fluidic connection to the volume of liquid within the liquid storage container, wherein the first one of the at least two needles is in fluidic communication with the liquid extraction outlet;
wherein a second one of the at least two needles is configured to provide a fluidic connection to the liquid storage container; and
wherein the liquid extraction mechanism is configured to supply air through the second one of the at least two needles.

17. A liquid extraction device according to any of claims 4 to 16 when dependent on claim 4, further comprising a resiliently deformable element configured to bias the piston away from the first configuration towards the second configuration.

18. A liquid extraction device according to claim 17, further comprising at least one clip configured to hold the piston in the first configuration, in which the resiliently deformable element is in a deformed state.

19. A liquid extraction device according to any of claims 1 to 18, further comprising a porous medium membrane in fluidic communication with the liquid extraction outlet.

20. A liquid extraction device for extracting liquid from a pierceable liquid storage container, the liquid extraction device comprising:
a chamber comprising an outlet configured to vent the chamber;
a first liquid storage container interface configured to provide a fluidic connection to a volume of liquid within the liquid storage container, the first liquid storage container interface comprising a liquid extraction outlet in fluidic communication with the chamber; and
a second liquid storage container interface configured to provide a fluidic connection to a volume of gas within the liquid storage container, wherein the second liquid storage container interface is configured to vent the volume of gas.

21. A liquid handling apparatus comprising:
a liquid handling device comprising one or more conduits; and
a liquid extraction device according to any of claims 1 to 20;
wherein the liquid extraction device is in fluidic communication with at least one of the one or more conduits.

22. A liquid handling apparatus according to claim 21, wherein the liquid extraction device is integrated within the liquid handling device.

23. A liquid handling apparatus according to claim 21, wherein the liquid extraction device is attachable to the liquid handling device.

24. A liquid handling apparatus according to claim 23, wherein the liquid extraction device is removably attachable to the liquid handling device.
